(19) United States
(12) Patent Application Publication
(10) Pub. No.: US 2008/0304102 A1
(43) Pub. Date: Dec. 11, 2008

(54) JOB MANAGEMENT APPARATUS, JOB MANAGEMENT METHOD, AND PROGRAM

(75) Inventor: Kazuyuki Saito, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/133,307

(22) Filed: Jun. 4, 2008

(30) Foreign Application Priority Data
Jun. 5, 2007 (JP) 2007-149557

(51) Int. Cl. G06F 3/12

(52) U.S. Cl. 358/1.15

(57) ABSTRACT

A job management apparatus includes a detecting unit configured to detect a plurality of exception setting items other than print settings applied to an entire print job from the print job; an instructing unit configured to instruct display of exception setting information for the exception setting items detected by the detecting unit; a selecting unit configured to allow selection of one of the exception setting items when the instructing unit instructs an exception setting item-based display; and a display unit configured to display such portion of the exception setting information relating to the exception setting item selected by using the selecting unit. A related method and computer implemented job management apparatus are also disclosed.

### BACKGROUND OF THE INVENTION

1. Field of the Invention

The present invention relates to a job management apparatus and a job management method for managing a print job, and a program for causing a computer to perform the job management method.

2. Description of the Related Art

Variable data is read from a database and is inserted to a template having a definition of areas into which the variable data is inserted. Thus, the variable data is laid out. The variable data is then printed. In this way, variable printing is achieved in which partially different printouts are output in one output operation (refer to, for example, Japanese Patent Laid-Open No. 10-27076).

In a commercial printing industry, a print vendor receives, from a client, an order to create printouts (e.g., magazines, newspapers, brochures, newspaper inserts, and photogravures) and, subsequently, generates a printout that the client desires, and delivers the printout to the client. Thus, the vendor can receive a payment. In general, the vendor generates printouts using a large-scale printing system, such as an offset printing machine.

In the commercial printing industry, the following variety of steps frequently need to be performed: receiving a manuscript, making a design and layout, making a comprehensive layout (a presentation using a printer output), proofreading (layout and color correction), proofprinting, making art work, printing, post-processing, and delivery. This is because the art work is indispensable for using the above-described printing system. After the art work is generated, it is difficult to modify the art work. In addition, the costs disadvantageously increase. Therefore, careful proofreading, that is, careful check of the layout and colors, is essential.

In the current commercial printing industry, a large-scale printing system is required, and a large amount of time is required for generating a printout that satisfies a requirement of a client. In addition, to perform these operation steps, special knowledge is required. That is, technical know-how known as a skill of a craftsman provided by experts is needed.

Electrographic printers and inkjet printers have been improved in terms of their speed and print resolution in recent years. Competing against the above-described commercial printing industry, a market known as printing on demand (POD) has been established. POD is aimed at processing a large number of copies and jobs in a short period for delivery without using a large-scale printing system and without using an existing printing method that are required for the current commercial printing industry. For example, in the POD market, to run a business, a digital print using electronic data is achieved by making the best use of digital image forming apparatuses, such as digital copiers and digital multifunction peripherals.

In such a POD market, digitization is more advanced than that in the current commercial printing industry, and it is common that management and control is performed using computers. The quality of printouts has been improved to the extent that is comparable to that in the commercial printing industry. In order to further expand the POD market, a reprint process in the printing workflow using digital image forming apparatuses needs to be further simplified. For example, in order to perform a reprint process, a job management apparatus is used. A job management apparatus manages a job that completed a printing process using, for example, a job ticket.

Furthermore, the POD provides a function in which a desired printout is printed repeatedly to produce the desired number of copies. If one document has a large number of pages, this document may be separated into a plurality of sub-documents and, subsequently, printed.

In such a case, in addition to print settings for the entire print job, print settings different from those for the entire print job can be set for part of the job in one job ticket. Hereinafter, these settings are referred to as “exception settings”. Examples of the exception settings include a stapling/non-stapling setting for a predetermined part, a color/monochrome setting for a predetermined part, and a sheet setting instructing a different type of sheet to be used only for a predetermined part.

For example, Japanese Patent Laid-Open Nos. 10-27076 and 2005-62916 describe a print processing method used for printing the above-described predetermined part. More specifically, Japanese Patent Laid-Open No. 10-27076 describes a technique in which desired page images are retrieved and are output to a printing apparatus. Japanese Patent Laid-Open No. 2005-62916 describes a technique in which the content is separated into blocks, and a print process is performed for each of the separate blocks.

In general, after print instruction data, such as a job ticket, is generated, a job management apparatus manages a job using the job ticket. However, it is difficult for the job management apparatus to retrieve the details of exception settings if the exception settings are set for a print job using one job ticket.

Suppose, for example, that a print job has 10 pages, an exceptional stapling setting is set for pages 3, 4, 8, and 9. In addition, an exceptional sheet size setting of “A3” is set for pages 3, 4, and 8. An exceptional sheet size setting of “A5” is set for page 7. An exceptional sheet size setting of “Letter” is set for pages 5 and 6. Furthermore, an exceptional sheet type setting of “Recycled paper” is set for pages 3 and 4. An exceptional sheet type setting of “Plain paper” is set for pages 5 and 6. An exceptional sheet type setting of “Label” is set for page 7. In this case, a print job including such exception settings is generated. The setting information about the print job is displayed as shown in FIG. 34. Accordingly, for example, the user cannot easily check the page range to which the exceptional stapling setting is applied. Furthermore, as the number of pages increases or the number of exception settings increases, the layout of the displayed information becomes more complicated. Thus, the user may not easily find set values of the exception settings.

### SUMMARY OF THE INVENTION

The present invention provides a job management apparatus and a job management method for providing a comfortable print processing environment in which the operation of the job management apparatus is simplified when a print job having exception settings is subjected to print processing.

According to an embodiment of the present embodiment, a job management apparatus includes a detecting unit configured to detect a plurality of exception setting items other than print settings applied to an entire print job from the print job, an instructing unit configured to instruct display of exception setting information for the exception setting items detected by the detecting unit, a selecting unit configured to allow selection of one of the exception setting items when the instructing unit instructs an exception setting item-based display, and a display unit configured to display such portion of the exception setting information relating to the setting item selected by using the selecting unit.

Further features of the present invention will become apparent from the following description of exemplary embodiments with reference to the attached drawings.

### BRIEF DESCRIPTION OF THE DRAWINGS

FIG. 1 is a block diagram of an exemplary functional structure of a job management apparatus according to a first embodiment of the present invention.

FIG. 2 is a schematic illustration of an exemplary print processing system including the job management apparatus according to the first embodiment.

FIG. 3 is a flow chart of an example operation procedure for displaying a print job on a display unit on an exception setting basis in the job management apparatus according to the first embodiment.

FIG. 4 is a flow chart of an exemplary internal processing procedure performed by the job management apparatus according to the first embodiment.

FIG. 5 is a flow chart illustrating a detailed processing procedure of an exception setting detection process performed in step S408 shown in FIG. 4.

FIG. 6 is a flow chart illustrating a detailed processing procedure of the sub-job ticket generating process performed at step S411 shown in FIG. 4.

FIG. 7A illustrates an example of exception setting information according to the first embodiment.

FIG. 7B illustrates an example of selectable processing parameter information for each of exception setting levels according to the first embodiment.

FIG. 7C illustrates an example of exception setting link information according to the first embodiment.

FIGS. 8A and 8B are schematic illustrations of a job management application and an example operation thereof relating to the example operation procedure illustrated in FIG. 3.

FIGS. 9A and 9B are schematic illustrations of a job management application and an example operation thereof relating to the example operation procedure shown in FIG. 3.

FIG. 10 is a flow chart of an example of a first operation processing procedure performed by the job management apparatus when setups are displayed on a display unit on an exception setting level basis, and a job that completed print processing is edited for each of the exception setting levels, according a second embodiment of the present invention.

FIG. 11 is a flow chart of an example of edit processing performed by the job management apparatus for each of the exception settings.

FIGS. 12A and 12B are schematic illustrations of a job management application and an exemplary operation of the job management application in the example of a first operation processing procedure illustrated in FIG. 10.

FIG. 13A illustrates an example of exception setting information updated in the processing performed at steps S1407 to S1409 of the flow chart in FIG. 14 according to the second embodiment.

FIG. 13B illustrates an example of exception setting link information updated in the processing at steps S1407 to S1409 of the flow chart in FIG. 14 according to the second embodiment.

FIG. 14 is a flow chart of an example of a second operation processing procedure performed by the job management apparatus when setups are displayed for each of the exception setting levels, and a job that completed print processing is edited for each of the exception setting levels, according the second embodiment.

FIGS. 15A and 15B are schematic illustrations of a job management application and an example operation thereof relating to the example second operation procedure illustrated in FIG. 14.

FIGS. 16A and 16B are schematic illustrations of a job management application and an example operation thereof relating to the example second operation procedure illustrated in FIG. 14.

FIGS. 17A and 17B are schematic illustrations of a job management application and an example operation thereof relating to the example second operation procedure illustrated in FIG. 14.

FIG. 18 is a flow chart of an example of a third operation processing procedure performed by the job management apparatus when setups are displayed on a display unit for each of the exception setting levels, and a job that completed print processing is edited for each of the exception setting levels, according the second embodiment.

FIGS. 19A and 19B are schematic illustrations of a job management application and an example operation thereof relating to the example third operation procedure illustrated in FIG. 18.

FIG. 20 is a flow chart of an example of an operation processing procedure performed by the job management apparatus when setups are displayed on a display unit for each of the exception setting levels, and a job that completed print processing is reprinted for each of the exception setting levels, according a third embodiment of the present invention.

FIG. 21 is a flow chart of an example of reprint processing performed by a job management apparatus according to the third embodiment for each of the exception settings.

FIG. 22 is a flow chart of a detailed processing procedure of a mini sub-job ticket generation process performed at a step shown in FIG. 21.

FIG. 23 illustrates an example of exception setting link information generated at a step in FIG. 22.

FIGS. 24A and 24B are schematic illustrations of a job management application and an example operation thereof relating to the example operation procedure illustrated in FIG. 20.

FIG. 25 is a flow chart of an example operation processing procedure performed by the job management apparatus when setups are displayed on a display unit for each of the exception setting levels, according a fourth embodiment of the present invention.

FIGS. 26A and 26B are schematic illustrations of a job management application and an example operation thereof relating to the example operation procedure shown in FIG. 25.

FIG. 27 is a flow chart of an example operation processing procedure performed by a job management apparatus when exception setting choices are displayed on a sheet-to-sheet basis, and a printed job is edited for an original document page or an original document page range, according a fifth embodiment of the present invention.

FIGS. 28A and 28B are schematic illustrations of a job management application and an example operation thereof relating to the example operation processing procedure illustrated in FIG. 27.

FIG. 29 is a flow chart of an example operation procedure performed by a job management apparatus when setups are displayed on a display unit on a sheet-to-sheet basis, and a printed job is reprinted for each of the sub-job tickets, according a sixth embodiment of the present invention.

FIGS. 30A and 30B are schematic illustrations of a job management application and an example operation thereof relating to the example operation procedure illustrated in FIG. 29.

FIG. 31 is a schematic illustration of an exemplary job ticket.

FIG. 32 is a schematic illustration of an exemplary sub-job ticket.

FIG. 33 is a schematic illustration of an exemplary mini sub-job ticket.

FIG. 34 illustrates an example display of exception setting information.

FIG. 35 is a block diagram of an exemplary hardware configuration of the job management apparatus.

### DESCRIPTION OF THE EMBODIMENTS

Various exemplary embodiment of the present invention are described below with reference to the accompanying drawings.

### First Embodiment

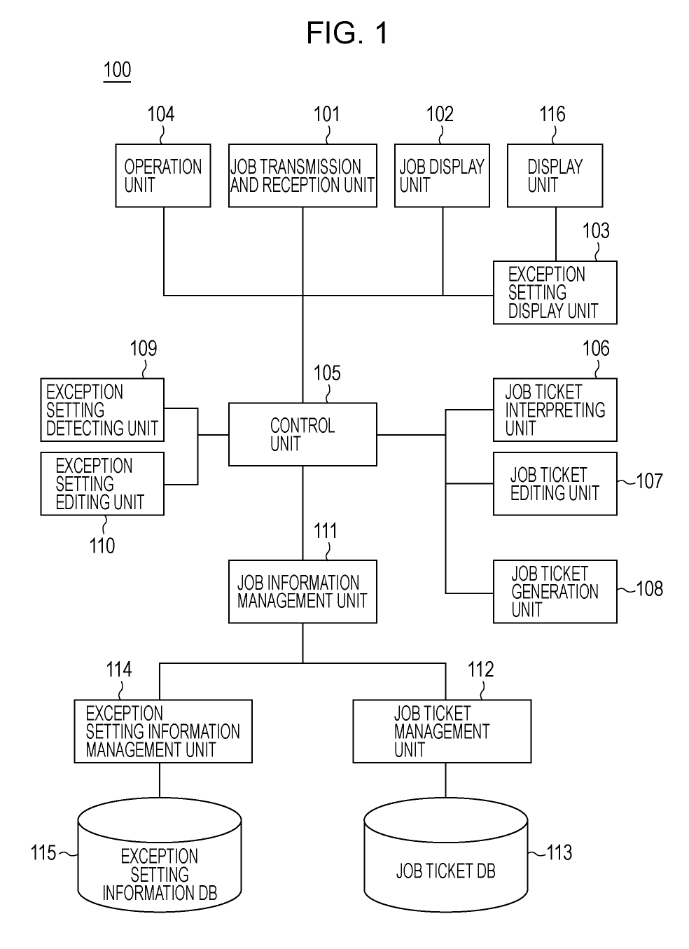

A first embodiment of the present invention is described below. FIG. 1 is a block diagram of an exemplary functional structure of a job management apparatus 100 according to a first embodiment of the present invention.

The job management apparatus 100 is composed of a computer apparatus including hardware, such as a central processing unit (CPU), a read only memory (ROM), a random access memory (RAM), and a hard disk (HD). The functions of the job management apparatus 100 illustrated in FIG. 1 are achieved by the CPU that executes programs of a job management application stored in the ROM or the HD.

As shown in FIG. 1, components 101 to 116 of the job management apparatus 100 are connected to each other using an internal bus so as to communicate with each other.

As shown in FIG. 1, a job transmission and reception unit 101 is used to transmit and receive all jobs exchanged between an external apparatus (e.g., a computer apparatus and a printing apparatus) and the job management apparatus 100. In addition, when a reprint process is performed, the job transmission and reception unit 101 transmits and receives only a job ticket. Examples of the transmitted and received job include an in-execution job indicating that processing, such as print processing, is in execution, a waiting job indicating that processing is in a waiting state, a termination job indicating that output processing is completed, and an error job indicating that an error occurred.

A job display unit 102 is used to control display of a list of jobs and the processing status of a job on a display unit 116. An exception setting display unit 103 is used to control display of exception setting information about a job on the display unit 116 for each of the exception settings. As used herein, the exception settings refer to settings (print settings) different from settings for an entire job (a print job), as described above.

An operation unit 104 is operated by an operator when the operator performs selection, modification, and deletion of one of jobs and one of exception setting items displayed on the display unit 116, performs a reprint process, and inputs a parameter.

A control unit 105 performs overall control of the job management apparatus 100. The control unit 105 performs control of each of the components (101 to 104, and 106 to 116) as needed.

A job ticket interpreting unit 106 is used to analyze a job ticket. More specifically, the job ticket interpreting unit 106 structurally analyzes a job ticket, and subsequently, semantically analyzes an instruction of processing. A job ticket editing unit 107 is used to edit the content of the job ticket.

During performance of a reprint process, a job ticket generation unit 108 generates a sub-job ticket for each of sheet ranges to which a different exception setting in a final process of an original job ticket is applied. The sub-job ticket is replaced with the original job ticket and serves as an instruction for a printing apparatus. In addition, the job ticket generation unit 108 separates the generated sub-job ticket into mini sub-job tickets.

An exception setting detecting unit 109 detects an exception setting in a job ticket. An exception setting editing unit 110 is used to edit an exception setting in a job ticket.

A job information management unit 111 performs overall management of job tickets by organizing storing a job ticket in the form of a file, retrieving the stored job ticket, storing exception setting information in the form of a file, and retrieving the stored exception setting information. The job information management unit 111 performs this management in cooperation with a job ticket management unit 112 and an exception setting information management unit 114 described below.

The job ticket management unit 112 controls storing a job ticket in the form of a file and retrieving the stored job ticket. A job ticket DB 113 is composed of an external storage unit for storing files of, for example, job tickets. As used herein, DB is an abbreviation for the term “database”.

The exception setting information management unit 114 controls storing exception setting information in the form of a file, extracting the stored exception setting information, and linking exception setting information pieces with each other. An exception setting information DB 115 is composed of an external storage unit for storing files of exception setting information.

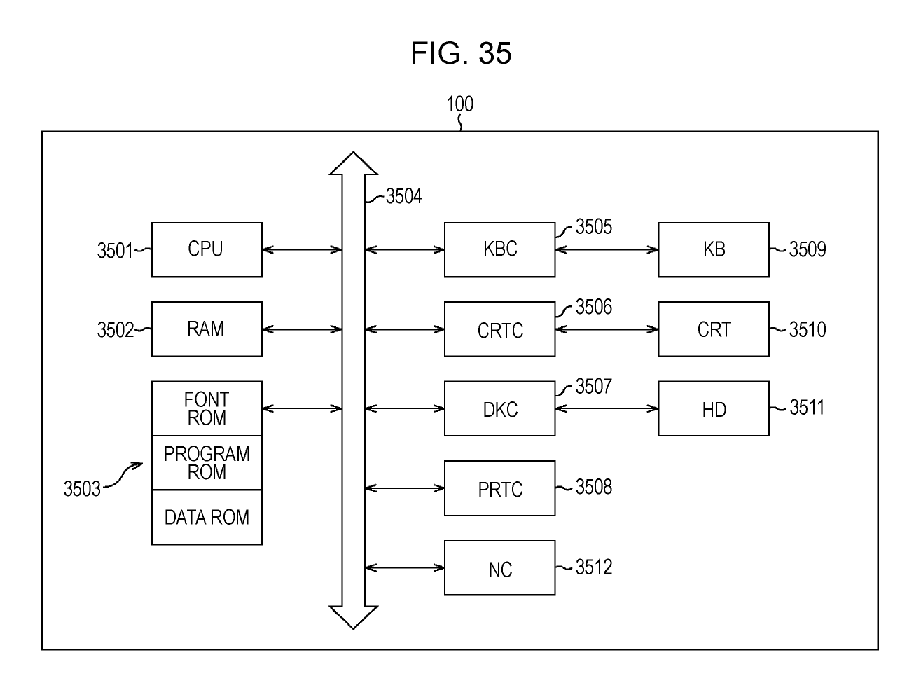

FIG. 35 is a block diagram of an exemplary hardware configuration of the job management apparatus 100 according to the first embodiment. For example, the job management apparatus 100 corresponds to an information processing apparatus.

In FIG. 35, a central processing unit (CPU) 3501 executes programs, such as an operating system (OS) and an application loaded from a read only memory (ROM) 3503 and a hard disk (HD) 3511 into a random access memory (RAM) 3502 so as to realize a procedure indicated by a flow chart described below. The RAM 3502 serves as a main memory and a work area of the CPU 3501. The ROM 3503 includes a font ROM, a program ROM, and a data ROM.

A keyboard controller (KBC) 3505 controls key inputs from a keyboard (KB) 3509 and a pointing device (not shown). A CRT controller (CRTC) 3506 controls display on a cathode ray tube (CRT) display 3510. A disk controller (DKC) 3507 controls accesses to the HD 3511 and a flexible disk (FD) (not shown), which store a boot program, a variety of applications, font data, user files, and an edit file described below. A print controller (PRTC) 3508 controls exchange of signals between the job management apparatus 100 and a connected printer apparatus. A network controller (NC) 3512 is connected to a network and performs a communication control process with other apparatuses connected to the network. A system bus 3504 connects the CPU 3501, the RAM 3502, the ROM 3503, the KBC 3505, the CRTC 3506, the DKC 3507, the PRTC 3508, and the NC 3512 with each other, and allows these components to communicate with each other. The KBC 3505, CRTC 3506, and DKC 3507 are also connected to and communicate with the KB 3509, CRT 3510, and HD 3511 respectively.

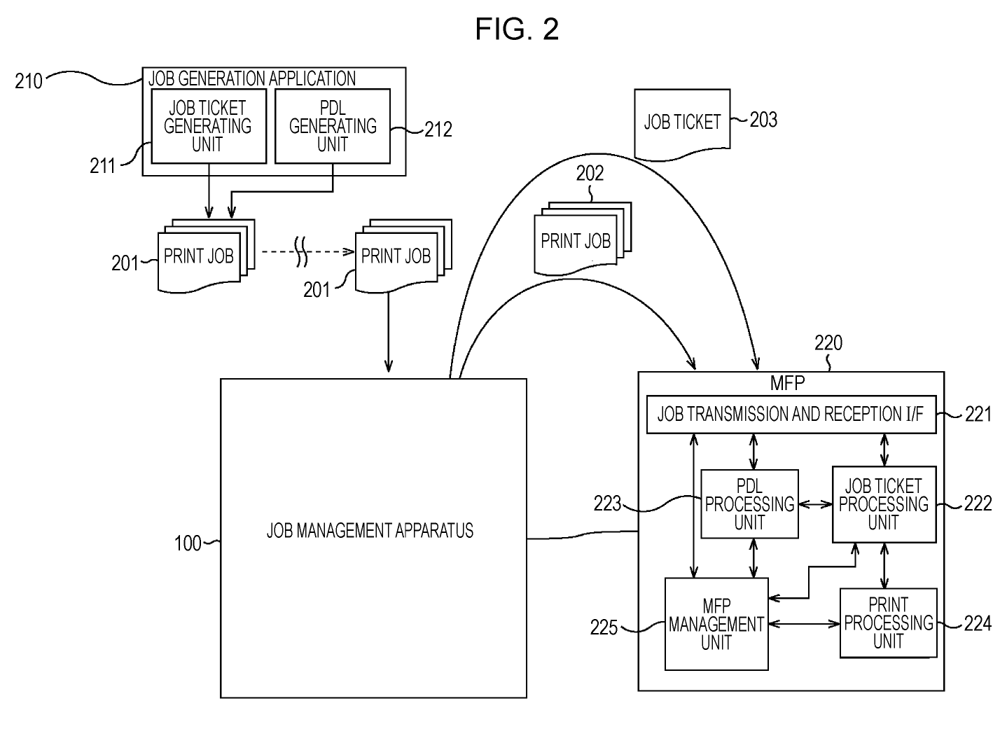

FIG. 2 is a schematic illustration of an exemplary print processing system including the job management apparatus 100 according to the first embodiment.

The print processing system illustrated in FIG. 2 includes the job management apparatus 100, a job generation application 210, and a multifunction peripheral (MFP) 220.

The job generation application 210 includes a job ticket generating unit 211 for generating a job ticket and a PDL generating unit 212 for generating print description language (PDL) data. These two units generate a print job 201. The print job 201 generated by the job generation application 210 is transmitted to the job management apparatus 100 illustrated in FIG. 1.

The MFP 220 receives a print job 202 and a job ticket 203 from the job management apparatus 100 and performs a variety of processing including print processing.

The MFP 220 includes a job transmission and reception I/F 221, a job ticket processing unit 222, a PDL processing unit 223, a print processing unit 224, and an MFP management unit 225. The job transmission and reception I/F 221 is used to transmit and receive a job. The job ticket processing unit 222 performs processing related to a job ticket. The PDL processing unit 223 performs processing related to a PDL. The print processing unit 224 performs print processing. The MFP management unit 225 performs overall control of the components of the MFP 220.

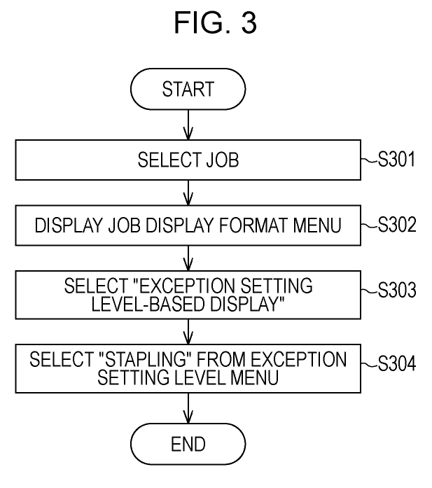

An exemplary process performed by the job management apparatus 100 according to the first embodiment is described below with reference to FIGS. 3 to 9B and FIGS. 31 and 32.

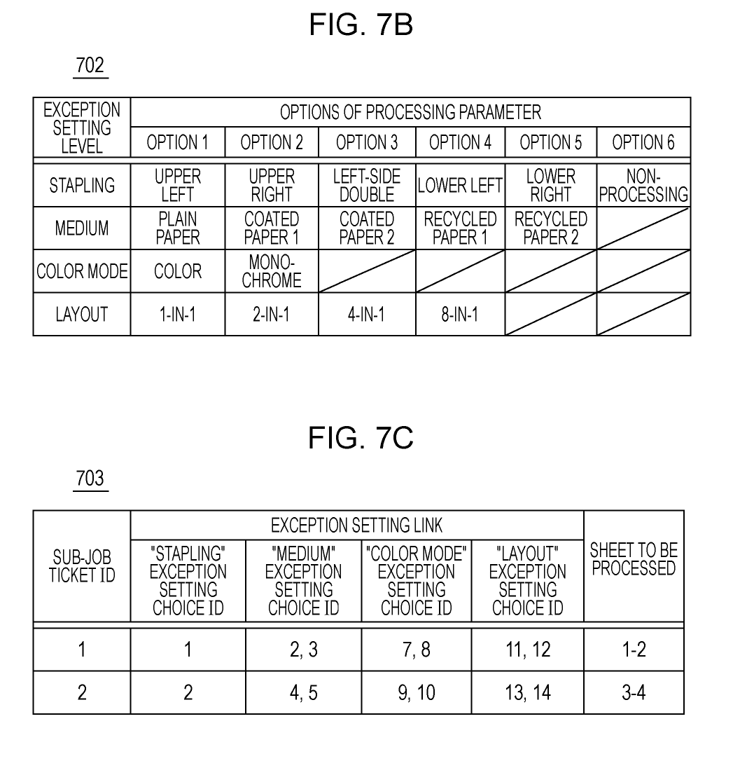

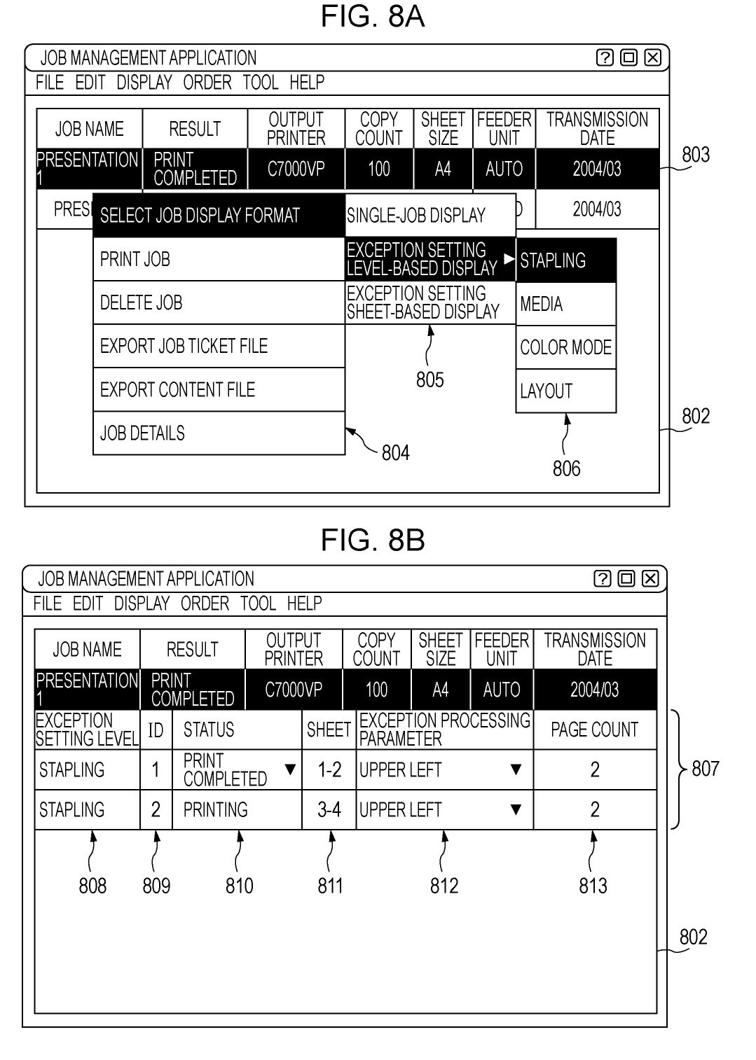

FIG. 3 is a flow chart of an example operation procedure for displaying the print job 201 on the display unit 116 on an exception setting basis in the job management apparatus 100 according to the first embodiment. At that time, the processes indicated by the flow chart of FIG. 3 are performed, for example, under the control of the control unit 105 illustrated in FIG. 1. FIGS. 8A, 8B, 9A, and 9B are schematic illustrations of a job management application and an operation thereof regarding the example operation procedure illustrated in FIG. 3.

The following description is made with reference to the case where a “single-job display” mode in which print settings of the print job 201 are displayed for the job is changed to an “exception setting level-based display” in which an exception setting choice is displayed for each of the exception settings, and the setting change choices are displayed for an exception setting level “Stapling”. Note that an exception setting is also referred to as an “exception setting level”.

At step S301, the control unit 105 starts a job management application so as to control the job display unit 102. Thus, a job list screen 802 illustrated in FIG. 8A is displayed on the display unit 116. Thereafter, the control unit 105 selects a job 803 which is selected by an operator through the operation unit 104.

Subsequently, at step S302, upon detecting a right-click of a pointing device of the operation unit 104 performed by the operator, the control unit 105 instructs the job display unit 102 to display a function menu 804 (901) in the job list screen 802, as illustrated in FIG. 8A. Thereafter, if the operator selects a menu item “Select Job Display Format” from the function menu 804 using the operation unit 104, the control unit 105 instructs the job display unit 102 to display a job display format menu 805 (902), as illustrated in FIG. 8A (FIG. 9A).

Subsequently, at step S303, the control unit 105 detects that the operator has selected a menu item “Exception setting level-based display” from the job display format menu 805 using the operation unit 104. The “Exception setting level-based display” means a process in which exception settings of a job are displayed on an exception setting level basis. Thereafter, the control unit 105 displays, for example, an exception setting level menu 806 on the job display unit 102, as illustrated in FIG. 8A. For example, the exception setting level menu 806 includes menu items “Stapling”, “Medium”, “Color mode”, and “Layout”. The exception setting choices are displayed in accordance with one of the exception setting levels (one of the exception settings). In addition to these menu items, for example, a menu item “Sheet Used for Printing” may be included.

Subsequently, at step S304, if the operator selects the menu item “Stapling” from the exception setting level menu 806 using the operation unit 104, the control unit 105 detects that selection and performs a selection process. The control unit 105 then instructs the exception setting display unit 103 to display exception setting choice information 807 for the exception setting level (“Stapling”) in the job list screen 802, as illustrated in FIG. 8B.

In FIG. 8B, an exception setting level field 808 indicates an exception setting level currently displayed. An ID field 809 indicates the ID of an associated sub-job ticket. A status field 810 indicates the status of printing. In addition, a sheet field 811 indicates the range of sheets to which the exception setting is applied. An exceptional processing parameter field 812 indicates a processing parameter for the exception setting. A page count field 813 indicates the number of pages printed or to be printed.

To further change the exception setting level displayed in the job list screen 802, processes at steps S302 to S304 are performed in a similar manner. For example, the case where the exception setting level is changed to a “Color Mode” is described next.

Since the processes performed at steps S302 to S303 are similar to those for the exception setting level “Stapling”, the detailed description is not repeated.

At step S304, when the operator selects a menu item “Color Mode” from an exception setting level menu 903 (FIG. 9A) using the operation unit 104, the control unit 105 detects that selection and performs a selection process. At that time, the control unit 105 instructs the exception setting display unit 103 to display print setting display information 904 as to the exception setting level “Color Mode” in the job list screen 802, as shown in FIG. 9B. Internal processing performed by the job management apparatus 100 when the operation illustrated in FIG. 3 is performed is described next.

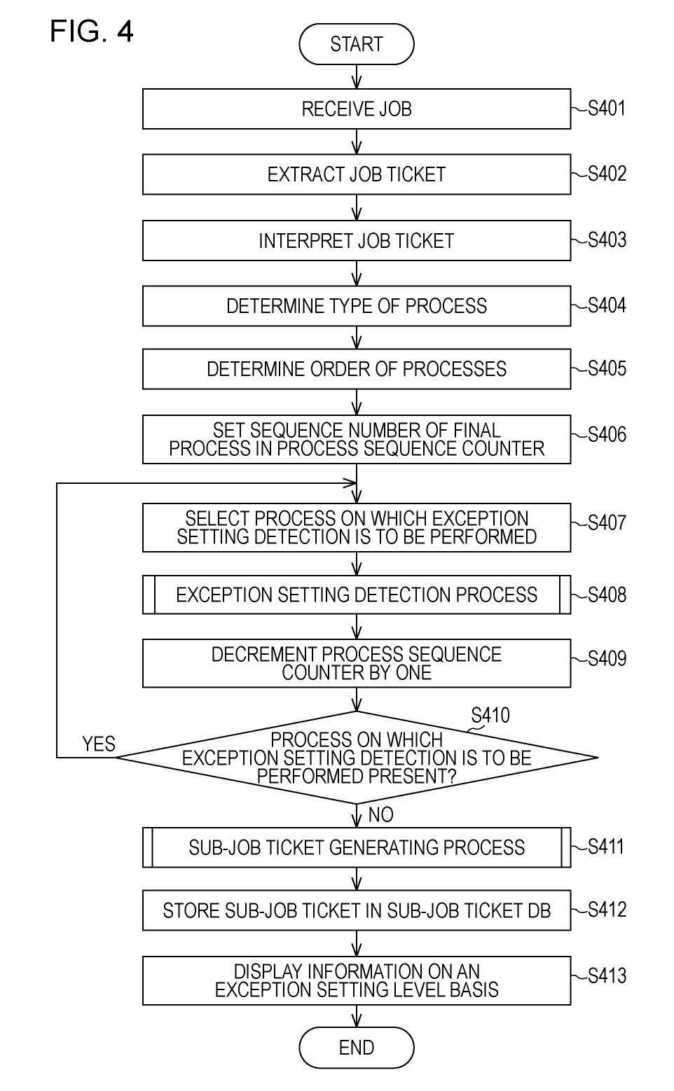

FIG. 4 is a flow chart of an exemplary internal processing procedure performed by the job management apparatus 100 according to the first embodiment. At that time, the processes indicated by the flow chart of FIG. 4 are performed, for example, under the control of the control unit 105 illustrated in FIG. 1.

First, at step S401, the job transmission and reception unit 101 receives a job (a print job 201) from the job generation application 210. At that time, for example, the job received by the job transmission and reception unit 101 is displayed in the job list screen 802 of the job management application, as shown in FIG. 8A.

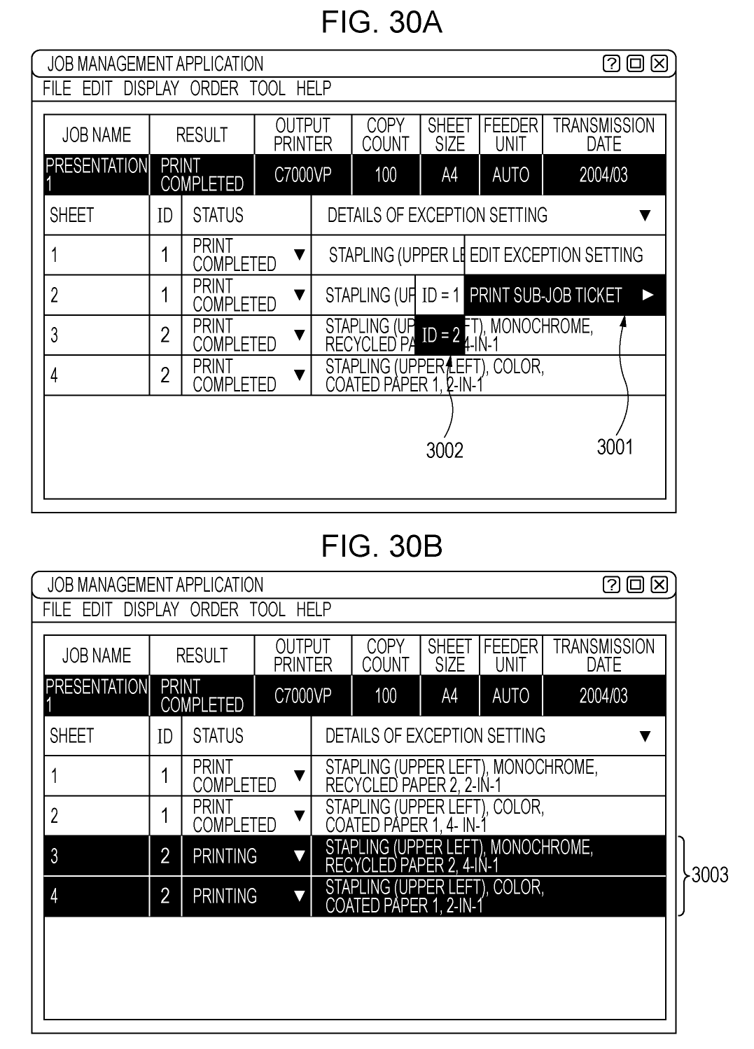

Subsequently, at step S402, the job information management unit 111 extracts a job ticket from the received job. FIG. 31 is a schematic illustration of an exemplary job ticket. In FIG. 31, a structure 3101 of a job ticket, processing 3102 triggered by the job ticket, and a relationship 3103 between a page of an original document and an exception setting level are illustrated.

Subsequently, at step S403, the job ticket interpreting unit 106 interprets the job ticket extracted by the job information management unit 111. More specifically, the job ticket interpreting unit 106 structurally analyzes the job ticket and then semantically interprets an instruction of processing.

At step S404, the job ticket interpreting unit 106 further determines the types of processing of the job ticket (hereinafter referred to “processes”) from the details of the instruction of the job ticket.

At step S405, the job ticket interpreting unit 106 further determines the order in which processes are to be executed on the basis of the input and output of data to and from the process determined at step S404 so as to assign, to the processes, sequence numbers that indicate the processing order of the processes. For example, in FIG. 31, numbers that indicate the order of processing are assigned to a layout determination process, a rendering process, a printing process, and a stapling process. Accordingly, a processing order position “1” is assigned to the layout determination process, and a processing order position “4” is assigned to the stapling process.

Subsequently, the exception setting detecting unit 109 sequentially selects the processes on which exception setting detection is to be performed in the reverse order of the printing process, (that is, in the reverse order starting from the final process), and detects exception setting choices.

More specifically, at step S406, the exception setting detecting unit 109 sets the final process sequence number in a process sequence counter. In the case shown in FIG. 31, the exception setting detecting unit 109 sets a processing order number “4” in the process sequence counter at step S406.

Subsequently, at step S407, the exception setting detecting unit 109 selects a process having a process sequence number equal to the count value in the process sequence counter as a process for which exception setting detection is to be performed. For example, in the case shown in FIG. 31, since the exception setting detecting unit 109 set a processing order number “4” in the process sequence counter at step S406, the exception setting detecting unit 109 selects the stapling process.

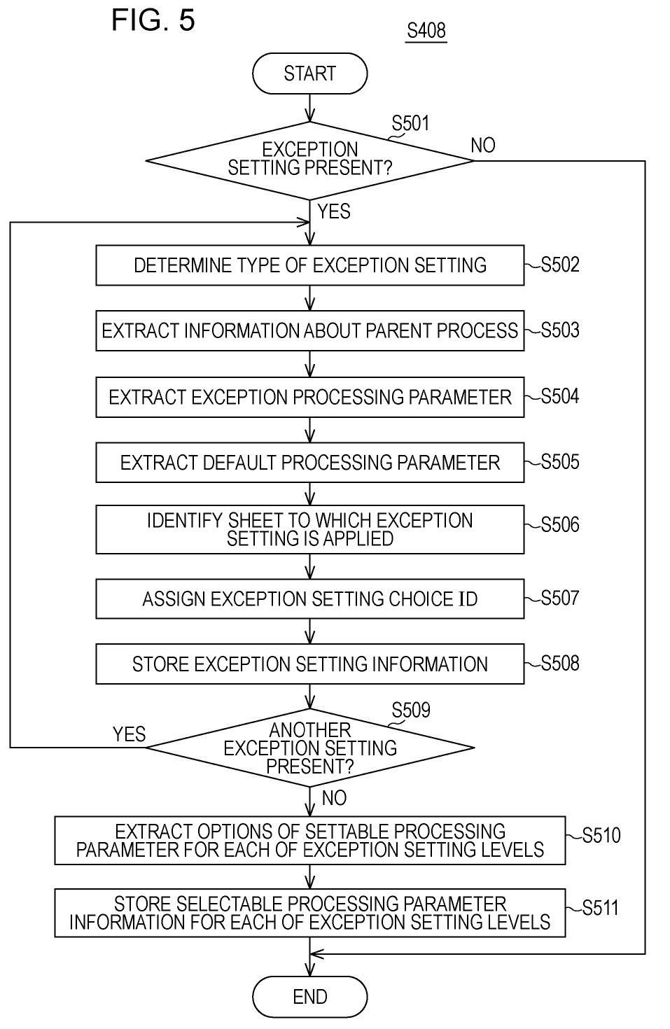

Subsequently, at step S408, the exception setting detecting unit 109 detects an exception setting in the process selected at step S407. The processing performed at step S408 is described below with reference to FIG. 5. Subsequently, at step S409, the exception setting detecting unit 109 decrements the count value in the process sequence counter by one. Thus, a previous process is found and becomes a next target for the exception setting detecting unit.

Subsequently, at step S410, the exception setting detecting unit 109 determines whether another process for which exception setting detection is to be performed is present. If another process for which exception setting detection is to be performed is present, the processing returns to step S407.

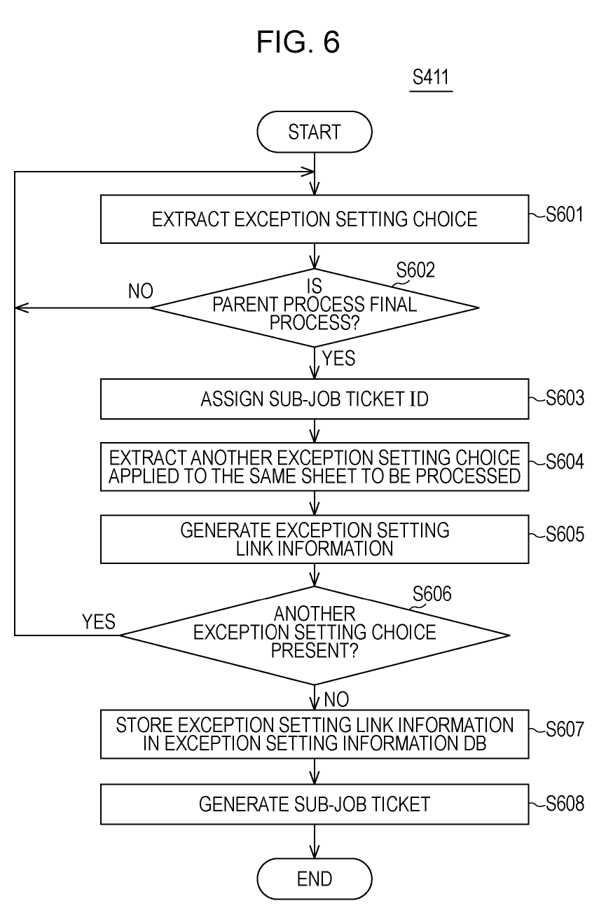

However, if, at step S410, it is determined that no other process for which exception setting detection is to be performed is present, the processing proceeds to step S411. At step S411, the job ticket generation unit 108 generates a sub-job ticket which is a subset of a job ticket extracted at step S402. The job ticket is divided by an exception setting level (each of exception settings) up to the final process. The processing at step S402 is described below with reference to FIG. 6.

Subsequently, at step S412, the job ticket management unit 112 stores the sub-job ticket generated at step S411 in the job ticket DB 113.

Subsequently, at step S413, the exception setting display unit 103 displays the information for each of the exception setting levels in the job list screen 802 displayed on the display unit 116.

When the processing at step S413 is completed, the processing illustrated by the flow chart given in FIG. 4 is completed.

The exception setting detection process performed at step S408 shown in FIG. 4 is described in detail next. FIG. 5 is a flow chart illustrating a detailed processing procedure of the exception setting detection process performed at step S408 shown in FIG. 4.

At step S501, the exception setting detecting unit 109 determines whether an exception setting is defined in the process on which exceptional setting detection is to be performed. More specifically, the exception setting detecting unit 109 determines whether a plurality of parameters are defined in each of the processes of the job ticket extracted at step S402. If a plurality of parameters are defined, it can be determined that a setting different from the setting for the entire job is defined. Accordingly, the exception setting detecting unit 109 determines that an exception setting is defined. As a result of the determination, if an exception setting is not defined in the process on which an exception setting detection is to be performed, the processing illustrated by the flow chart is completed. The processing then proceeds to step S409 shown in FIG. 4.

However, as a result of the determination at step S501, if an exception setting is defined in the process on which an exception setting detection is to be performed, the processing proceeds to step S502. At step S502, the exception setting detecting unit 109 determines the type of exception setting defined in the process on which exception setting detection is to be performed. This type is extracted as an exception setting level (in this example, one of “Stapling”, “Media”, “Color Mode”, and “Layout” shown in FIGS. 8 and 9). More specifically, for example, in the case of the processing order of “4”, the exception setting detecting unit 109 identifies a process corresponding to the processing order of “4” in the job ticket shown in FIG. 31. Accordingly, the “Stapling process” is identified.

Subsequently, at step S503, the exception setting detecting unit 109 extracts information about the process from which the exception setting is detected (in this example, a “process name” and a “processing order”).

Subsequently, at step S504, the exception setting detecting unit 109 extracts the exception processing parameters for each of the exception setting choices (in this example, “upper left” shown in FIG. 8B for an exception setting level “Stapling”). Note that the processing at steps S503 and S504 is performed by interpreting the job ticket illustrated in FIG. 31.

Subsequently, at step S505, the exception setting detecting unit 109 extracts a default processing parameter other than the exception setting parameter (in this example, “non-processing”). More specifically, the exception setting detecting unit 109 acquires default processing parameters set for an apparatus that is a transmission target of the job ticket and set for an application that transmits the job ticket. In this way, the processing at step S505 is performed.

Subsequently, at step S506, the exception setting detecting unit 109 refers to the job ticket and determines sheets to be subjected to the exception setting choice for each of the exception setting levels. More specifically, when the current processing is performed for “Stapling”, the exception setting detecting unit 109 detects sheet numbers for the target parameter contained in a “stapling process” field of the job ticket. In an example shown in FIG. 31, sheet numbers for a first parameter are 1 to 2. Accordingly, the exception setting detecting unit 109 identifies the sheets 1 to 2.

Subsequently, at step S507, the exception setting detecting unit 109 assigns a unique exception setting choice ID to each of the exception settings.

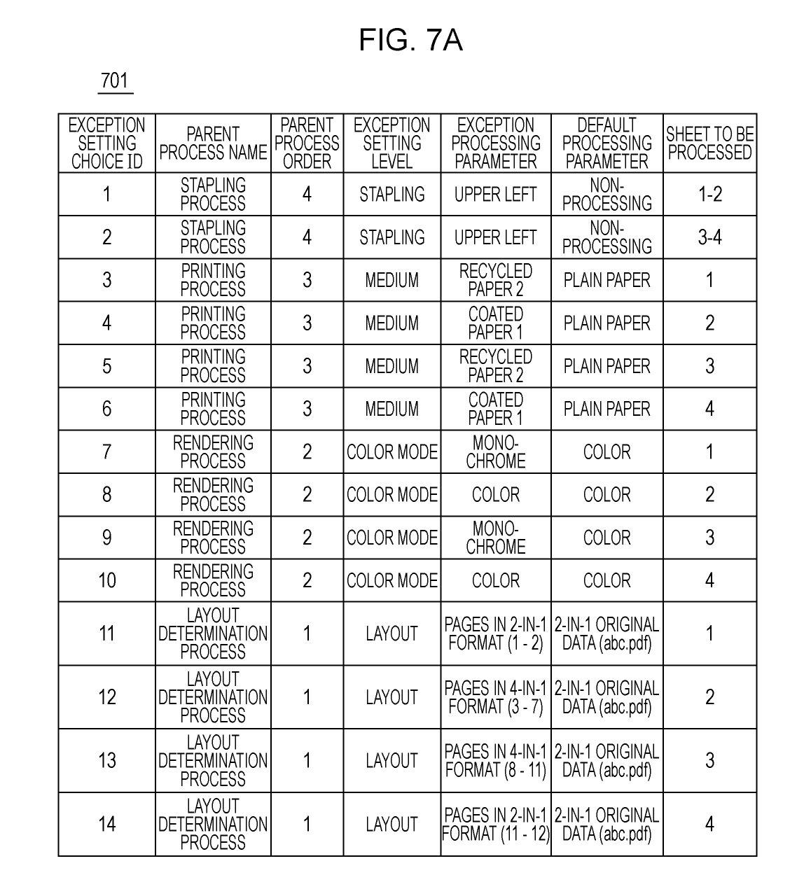

At step S508, the exception setting information management unit 114 stores, in the exception setting information DB 115, the information about the exception setting extracted and added by the exception setting detecting unit 109 as exception setting information. FIG. 7A illustrates an example of exception setting information 701 according to the first embodiment.

Subsequently, at step S509, the exception setting detecting unit 109 determines whether another exception setting choice is defined for the process from which exception settings are to be detected. As a result of determination, if another exception setting is defined, the processing returns to step S502.

However, as a result of determination at step S509, if another exception setting is not defined for the process for which exception setting detection is to be performed, the processing proceeds to step S510. At step S510, the exception setting detecting unit 109 extracts an option for a possible processing parameter value for each of the exception setting levels using the job ticket interpreting unit 106. More specifically, the exception setting detecting unit 109 extracts options of a settable processing parameter value from a destination apparatus of the job ticket and an origin application of the job ticket. For example, the destination apparatus has options “Saddle stitching”, “Upper left”, “Lower left”, “Upper right”, and “Lower right” of a stapling process, these values are extracted.

Subsequently, at step S511, the exception setting information management unit 114 stores, in the exception setting information DB 115, the options of the settable processing parameter for each of the exception setting levels extracted by the exception setting detecting unit 109 as selectable processing parameter information for each of the exception setting levels. FIG. 7B illustrates an example of selectable processing parameter information 702 for each of the exception setting levels according to the first embodiment.

When the processing at step S511 is completed, the processing illustrated by the flow chart given in FIG. 5 is completed.

A sub-job ticket generating process performed at step S411 shown in FIG. 4 is described in detail next. FIG. 6 is a flow chart illustrating a detailed processing procedure of the sub-job ticket generating process performed at step S411 shown in FIG. 4.

The exception setting information management unit 114 generates link information about individual exception setting choices in the exception setting information 701 stored in the exception setting information DB 115.

More specifically, at step S601, the exception setting information management unit 114 extracts each of the exception setting choices from the exception setting information 701 stored in the exception setting information DB 115 at step S508 (refer to FIG. 7A). For example, in FIG. 7A, fourteen exception setting choices are stored. Accordingly, the exception setting information management unit 114 sequentially extracts the exception setting choice in the ascending order of the exception setting choice ID (e.g., the exception setting choice having an exception setting choice ID of “1” is extracted first in FIG. 7A).

Subsequently, at step S602, the exception setting information management unit 114 determines whether the exception setting choice extracted at step S601 belongs to the final process. As a result of the determination, if the exception setting choice extracted at step S601 does not belong to the final process, the processing returns to step S601. For example, in FIG. 7A, upon extracting the exception setting choice having an exception setting choice ID of “1”, the exception setting information management unit 114 obtains the exception setting level “Stapling” and refers to the job ticket illustrated in FIG. 31. In this way, the exception setting information management unit 114 can determine that the exception setting level “Stapling” belongs to the final process.

However, as a result of the determination at step S602, if the exception setting choice extracted at step S601 belongs to the final process, the processing proceeds to step S603. At step S603, the exception setting information management unit 114 assigns a sub-job ticket ID to the extracted exception setting choice.

Subsequently, at step S604, the exception setting information management unit 114 extracts another exception setting choice to be applied to the same sheet to be processed. For example, when an exception setting choice ID of “1” is currently being processed in FIG. 7A, the exception setting information management unit 114 recognizes that the sheets to be processed are sheets 1-2. Accordingly, the exception setting information management unit 114 extracts another exception setting choice to be applied to sheet “1” or “2”. For example, in the case of the exception setting information illustrated in FIG. 7A, the exception setting information management unit 114 extracts the exception setting choice IDs “3”, “4”, “7”, “8”, “11” and “12” as the other exception setting choices that are applied to the same sheets.

Subsequently, at step S605, the exception setting information management unit 114 generates exception setting link information on the basis of the extraction result obtained at step S604. FIG. 7C illustrates an example of exception setting link information 703 according to the first embodiment.

Subsequently, at step S606, the exception setting information management unit 114 determines whether another exception setting choice that is not subjected to the link processing is present in the exception setting information 701 shown in FIG. 7A. As a result of the determination, if another exception setting that is not subjected to the link processing is present, the processing returns to step S601. For example, in FIG. 7A, when the link processing is performed for the exception setting choice ID “1”, but is not performed for the exception setting choice ID “2”, the processing returns to step S601.

However, as a result of the determination at step S606, if no other exception setting choice that has not yet been subjected to the link processing is present, the processing proceeds to step S607. At step S607, the exception setting information management unit 114 stores the exception setting link information 703 generated at step S605 in the exception setting information DB 115.

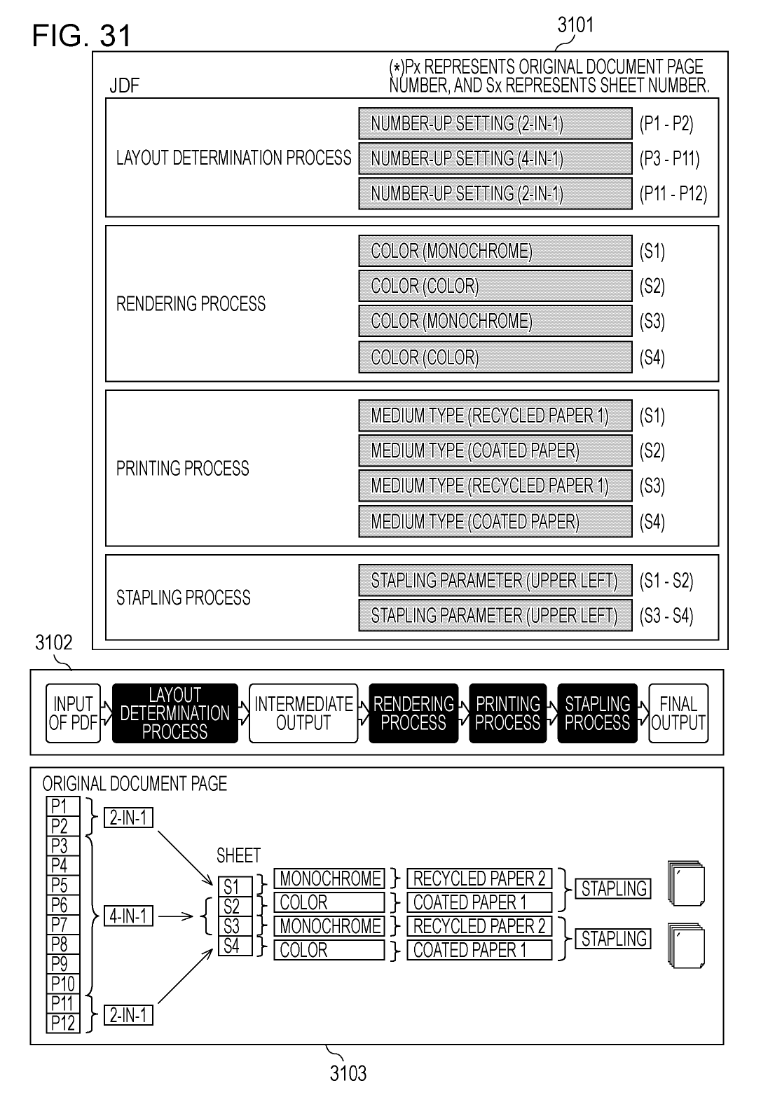

Subsequently, at step S608, the job ticket generation unit 108 generates a sub-job ticket from the exception setting link information 703. FIG. 32 is a schematic illustration of an exemplary sub-job ticket. More specifically, FIG. 32 illustrates a sub-job ticket structure 3201 for ID=“1” and a sub-job ticket structure 3202 for ID=“2”. As described below, the sub-job ticket is generated on the basis of the exception setting link information generated at step S605.

When the processing at step S608 is completed, the processing illustrated by the flow chart given in FIG. 6 is completed.

As described above, according to the first embodiment, a mechanism is provided that enables exception setting choices to be displayed on an exception setting level basis for a print job having exceptional settings. Accordingly, the operator can easily recognize print setups for each of the exception setting levels, and therefore, the processing efficiency can be increased. Thus, according to the first embodiment, the job management apparatus 100 can provide an easy printing operation regarding the exception settings and a comfortable printing process environment.

### Second Embodiment

A second embodiment of the present invention is described below. A job management apparatus according to the second embodiment has a functional structure that is the same as or alternatively similar to that of the job management apparatus 100 according to the first embodiment illustrated in FIG. 1. In addition, a print processing system according to the second embodiment has a configuration that is the same as or alternatively similar to that of the print processing system according to the first embodiment illustrated in FIG. 2. However, the following description delineates how the second embodiment differs from the first embodiment.

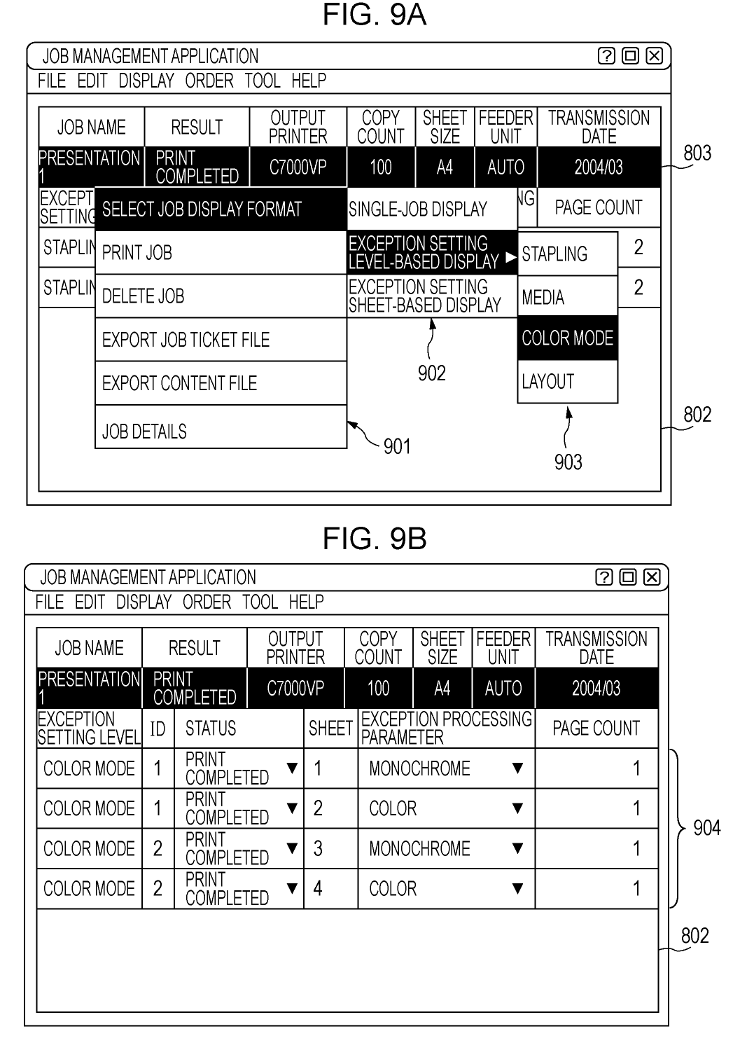

Exemplary processing of a job management apparatus 100 according to the second embodiment is described next with reference to FIGS. 10 to 19.

FIG. 10 is a flow chart of an example of a first operation processing procedure performed by the job management apparatus 100 when exception setting choices are displayed on a display unit 116 on an exception setting level basis, and a job for which print processing is completed is edited for the exception setting level, according the second embodiment. At that time, the processes illustrated in a flow chart shown in FIG. 10 are performed under the control of the control unit 105 shown in FIG. 1, for example.

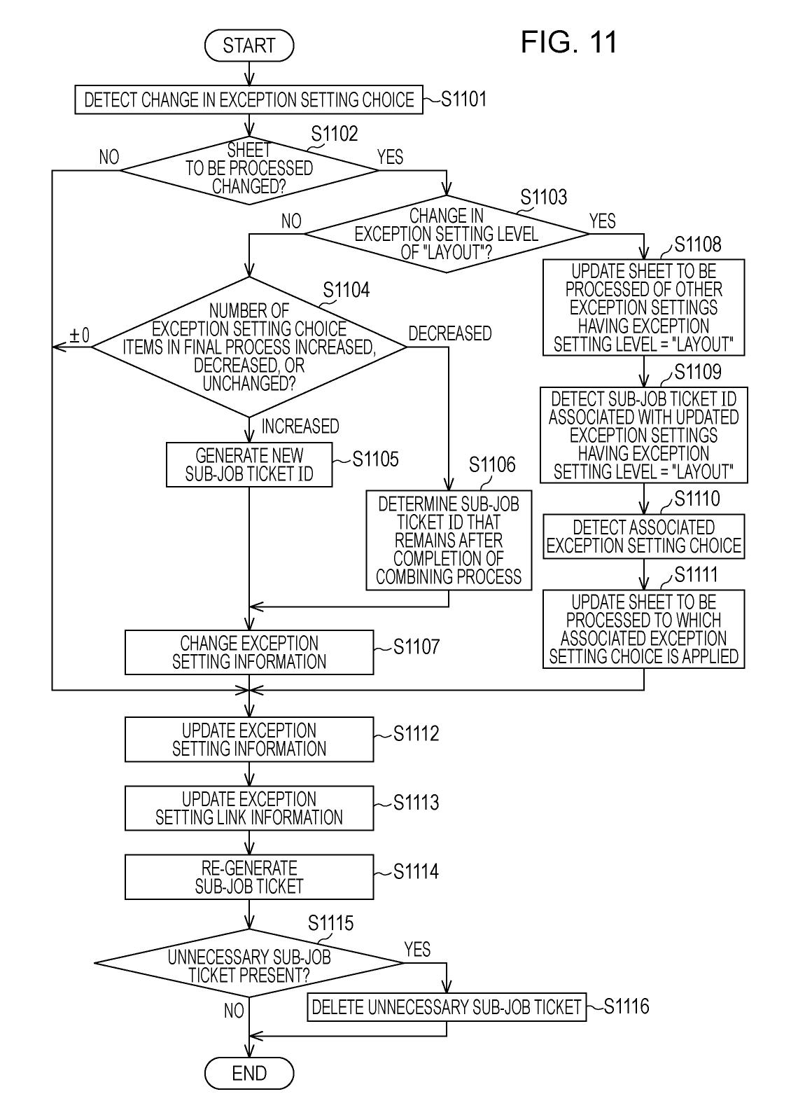

FIGS. 12A and 12B are schematic illustrations of a job management application and an exemplary operation of the job management application regarding the example of the first operation processing procedure illustrated in FIG. 10. For example, a job management application screen 1201 in FIG. 12A illustrates a transition in which the print setting for a job having an exception setting level “Stapling” is changed. In addition, a job management application screen 1204 in FIG. 12B illustrates a transition in which the print setting for a job having an exception setting level “Color Mode” is changed. The processing procedures for the job management applications screens 1201 and 1204 are performed in accordance with the flow chart shown in FIG. 10.

As shown in FIG. 10, at step S1001, upon receiving an instruction for exception setting level-based display from an operator via the operation unit 104, the control unit 105 performs a predetermined process illustrated in the flow chart shown in FIG. 3. Thus, information is displayed on the display unit 116 for one of the exception setting levels. More specifically, for example, the control unit 105 instructs the exception setting display unit 103 to display, on the display unit 116, the job management application screen 1201 as shown in FIG. 12A or the job management application screen 1204 as shown in FIG. 12B.

Subsequently, at step S1002, when the operator selects one of the entries of “Exception Processing Parameter” field (e.g., an entry 1202 or 1205 shown in FIGS. 12A and 12B) of an exception setting level using the operation unit 104, the control unit 105 detects this selection. The control unit 105 then performs control so as to cause the exception setting display unit 103 to display the exception processing parameter menu (e.g., a menu 1203 or 1206 shown in FIGS. 12A and 12B) on the display unit 116.

Subsequently, at step S1003, when the operator selects one of the menu items from the exception processing parameter menu using the operation unit 104, the control unit 105 instructs the exception setting display unit 103 to update the display of the exception setting level-based job list screen automatically.

Exemplary processing performed by the job management apparatus 100 according to the second embodiment in the operation procedure shown in FIG. 10 is described next.

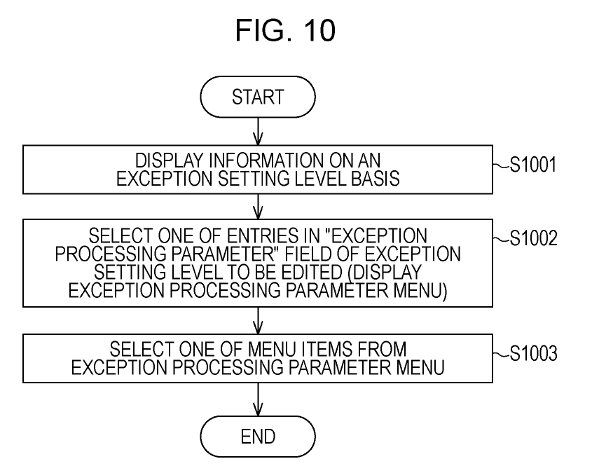

FIG. 11 is a flow chart of an example of edit processing performed by the job management apparatus 100 of the second embodiment for one of the exception setting choices. At that time, the processing illustrated in a flow chart shown in FIG. 11 is performed under the control of the control unit 105 shown in FIG. 1, for example.

When the operator instructs editing of an exception setting choice using the operation unit 104, and the exception setting editing unit 110 updates the exception setting choice specified by the operator, the exception setting information management unit 114, at step S1101, detects the updating of the exception setting choice.

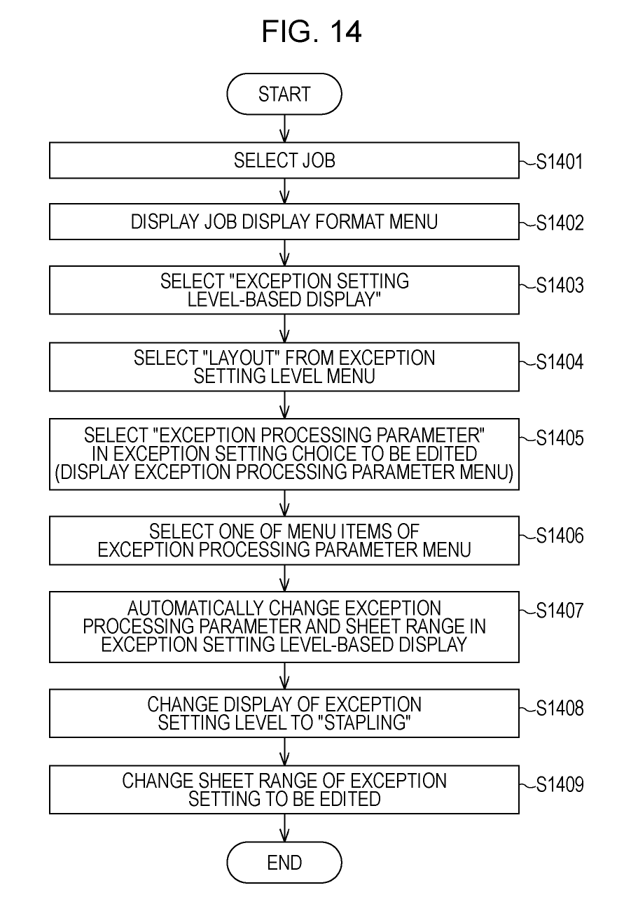

Subsequently, at step S1102, the exception setting information management unit 114 determines whether the sheet information is updated in accordance with the update of the exception setting choice detected at step S1101. More specifically, for example, as shown in FIGS. 16A and 16B, when the layout setting is changed from “4-in-1” to “2-in-1”, the number of sheets increases. In such a case, the exception setting information management unit 114 determines that the sheets to be processed are updated. Another example in which it is determined at step S1102 that the sheet information is to be updated is the case where sheets to be subjected to a stapling process are updated. As a result, in FIGS. 16A and 16B, the sheet range to which the updated layout setting is applied is changed in accordance with the update of the layout setting.

As in the example shown in FIG. 10, if the sheet to be processed is not changed, only information pieces of the exception setting information and the exception setting link information related to the updated exception setting choice are updated.

That is, in this example, it is determined at step S1102 that the sheets to be processed are not changed, and therefore, the processing proceeds to step S1112. At step S1112, the exception setting information management unit 114 changes and updates only information pieces related to the updated exception setting choice.

Subsequently, at step S1113, the exception setting information management unit 114 updates only the information in the exception setting information related to the updated exception setting.

Subsequently, at step S1114, the job ticket generation unit 108 regenerates a sub-job ticket.

Subsequently, at step S1115, for example, the job ticket management unit 112 determines whether an unnecessary sub-job ticket is present. Examples of the unnecessary sub-job ticket include the previously generated sub-job ticket of the sub-job ticket regenerated at step S1114.

As a result of the determination at step S1115, if an unnecessary sub-job ticket is present, the processing proceeds to step S1116. At step S1116, the job ticket management unit 112 deletes the unnecessary sub-job ticket from the job ticket DB 113.

However, if, at step S1115, it is determined that an unnecessary sub-job ticket is not present or if the processing at step S1116 is completed, the processing illustrated by the flow chart given in FIG. 11 is completed.

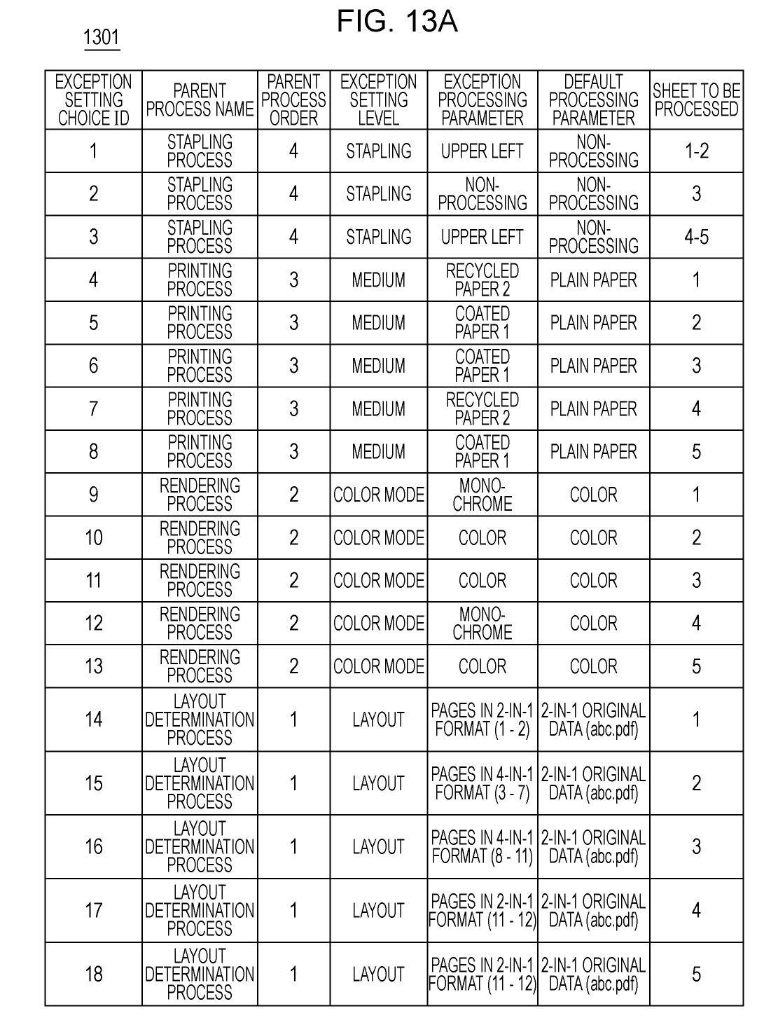

FIG. 14 is a flow chart of a second example of operation processing procedure performed by the job management apparatus 100 when setups are displayed on an exception setting level basis, and a job that completed print processing is edited on an exception setting level basis, according the second embodiment. At that time, the processing illustrated by a flow chart given in FIG. 14 is performed under the control of the control unit 105 shown in FIG. 1, for example.

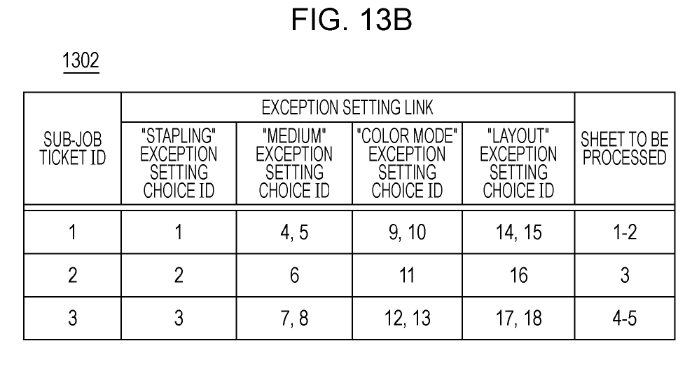

FIGS. 15, 16, and 17 are schematic illustrations of example screens provided by the job management application and related to the second example of operation processing procedure illustrated in FIG. 14.

In the following description, for example, one of the exception setting choices having the exception setting level “Layout” is changed from “4-in-1” to “2-in-1”, and the range for “Stapling” is changed. Thus, three booklets are generated in place of two booklets. However, it should be noted that the processing of the flow chart in FIG. 14 can be applied when exception setting choices having other exception setting levels are changed.

In this example, at step S1401, the control unit 105 starts the job management application so as to control the job display unit 102. Thus, a job list screen illustrated in FIG. 15A is displayed on the display unit 116. Thereafter, the control unit 105 selects a job 1500 which was selected by an operator through the operation unit 104.

Subsequently, at step S1402, when the control unit 105 detects a right-click of a pointing device of the operation unit 104 performed by the operator, the control unit 105 instructs the job display unit 102 to display a function menu 1501 illustrated in FIG. 15A in the job list screen. Thereafter, when the operator selects a menu item “Select job display format” from the function menu 1501 using the operation unit 104, the control unit 105 instructs the job display unit 102 to display a job display format menu 1502 as illustrated in FIG. 15A.

Subsequently, at step S1403, the control unit 105 detects that the operator has selected a menu item “Exception setting level-based display” from the job display format menu 1502 using the operation unit 104. The “Exception setting level-based display” represents a mode in which exception setting choices for a job are displayed on an exception setting level basis. Thereafter, the control unit 105 instructs the job display unit 102 to display an exception setting level menu 1503, as illustrated in FIG. 15A. The exception setting level menu 1503 includes the following menu items: “Stapling”, “Medium”, “Color Mode”, and “Layout”. The exception setting choices are displayed for one of the exception setting levels (the exception setting). In addition, as an example of the menu items, an item “Sheet used for printing” can be added.

Subsequently, at step S1404, when the operator selects the item “Layout” from the exception setting level menu 1503 using the operation unit 104, the control unit 105 detects this selection and performs a selection process. The control unit 105 then instructs the exception setting display unit 103 to display exception setting choice information 1504 for exception setting level (‘Layout’) in the job list screen, as illustrated in FIG. 15B.

Subsequently, at step S1405, when the operator selects an “Exception processing parameter” (column) of “Exception setting level” (row) to be edited using the operation unit 104, the control unit 105 detects this selection. Thereafter, for example, the control unit 105 instructs the exception setting display unit 103 to display an exception processing parameter menu on the display unit 116. As shown in the job list screen of FIG. 15B, if, for example, an item “4-in-1” of the exception processing parameter for ID=1 is selected, the control unit 105 instructs the exception setting display unit 103 to display an exception processing parameter menu 1601, as shown in FIG. 16A.

Subsequently, at step S1406, when the operator selects one of the menu items (“2-in-1” in this example) from the exception processing parameter menu 1601 using the operation unit 104, the control unit 105 detects this selection. Thereafter, the control unit 105 instructs the exception setting display unit 103 to automatically update the display of the exception setting choice 1602 (see FIG. 16B) in the job list screen. At that time, the sheet information is changed in the exception setting choice 1602 because the number of sheets is increased by changing “4-in-1” to “2-in-1”, as illustrated in FIG. 16A.

Example processing performed by the job management apparatus 100 according to the second embodiment for the operation processes at steps S1401 to S1406 is described below with reference to FIG. 11.

When the operator instructs editing of the exception setting choice using the operation unit 104, the exception setting editing unit 110 updates the exception setting in accordance with the instruction. At that time, the exception setting information management unit 114, at step S1101, detects the updating of the exception setting choice.

Subsequently, at step S1102, the exception setting information management unit 114 determines whether the sheet information is changed.

In this example, since the sheet information is changed, the processing proceeds to step S1103. At step S1103, the exception setting information management unit 114 determines whether the exception setting level of the updated exception setting choice is “Layout”.

In this example, since the exception setting level of the updated exception setting choice is “Layout” as shown in FIG. 15A, the processing proceeds to step S1108.

In this example, the exception setting level of the updated exception setting choice is “Layout” as shown in FIG. 15A, and “4-in-1” shown in FIG. 16A is changed to “2-in-1”. Accordingly, as shown in FIG. 16B, the sheet range of the exception setting choice 1602 is changed from “2” to “2-3”.

As a result of this change, the sheet range information in the other exception setting choices needs to be changed. Accordingly, at step S1108, the exception setting information management unit 114 updates the sheet range information in the other exception setting choices. More specifically, in this example, as shown by an exception setting choice 1603 in FIG. 16B, the sheet range information of the exception setting choice 1603 is changed from “3” to “4”. In addition, as shown by an exception setting choice 1604, the sheet range information of the exception setting choice 1604 is changed from “4” to “5”.

Subsequently, at step S1109, the exception setting information management unit 114 detects a sub-job ticket ID associated with all of the updated exception setting level fields. More specifically, in this example, as shown in FIGS. 16A and 16B, the sheet range information of the lower three exception setting choices (exception setting choices 1602 to 1604) of the four exception setting choices are changed. Accordingly, at step S1109, the exception setting information management unit 114 detects a sub-job ticket ID “1” associated with the exception setting choice 1602. Similarly, the exception setting information management unit 114 detects a sub-job ticket ID “2” associated with the exception setting choice 1603 and a sub-job ticket ID “2” associated with the exception setting choice 1604.

Subsequently, at step S1110, the exception setting information management unit 114 detects an associated exception setting choice using the exception setting link information and the detected sub-job tickets. More specifically, in FIGS. 16A and 16B, the layout applied to a sheet “2” is updated. Update is performed for the exception setting choice ID “12”. In this example, the exception setting choice ID “12” belongs to the sub-job ticket ID “1”. Therefore, at step S1110, the exception setting choices excluding one having the exception setting choice ID “12” assigned thereto are detected for the sub-job ticket ID “1”.

Subsequently, at step S1111, the exception setting information management unit 114 updates the sheet information for the associated exception setting choices detected at step S1110 on the basis of the sheet range information of the exception setting choices having the exception setting level “Layout” and associated with the same sub-ticket ID. More specifically, in this example, at step S1110, the exception setting choices excluding one having the exception setting choice ID “12” assigned thereto are detected as the exception setting choices associated with the sub-ticket ID “1” (i.e., the exception setting choices having IDs “1”, “3”, “4”, “7”, “8”, and “11” are detected). The exception setting information management unit 114 updates the sheet information of the exception setting choices having the detected exception setting choice IDs from “1-2” to “1-3”.

Subsequently, at step S1112, the exception setting information management unit 114 updates only pieces of the exception setting information associated with the updated exception setting choice.

Subsequently, at step S1113, the exception setting information management unit 114 updates only pieces of the exception setting link information associated with the updated exception setting choice. That is, as described above, the sheet information is updated in accordance with the update of the layout. Since the exception setting link information is generated on the basis of the sheet information, the exception setting link information is updated in accordance with the update of the sheet information.

Subsequently, at step S1114, the job ticket generation unit 108 regenerates a sub-job ticket.

Subsequently, at step S1115, the job ticket management unit 112 determines whether an unnecessary sub-job ticket is present.

As a result of the determination at step S1115, if an unnecessary sub-job ticket is present, the processing proceeds to step S1116. At step S1116, the job ticket management unit 112 deletes the unnecessary sub-job ticket from the job ticket DB 113.

However, if it is determined at step S1115 that an unnecessary sub-job ticket is not present, or the processing at step S1116 is completed, the processing illustrated by the flow chart given in FIG. 11 is completed.

Referring back to FIG. 14, after processing at step S1406 is completed, the control unit 105, at step S1407, instructs the exception setting display unit 103 to automatically update the exception setting parameter and the sheet range in the exception setting level-based display. The control unit 105 updates the displayed information on the basis of the exception setting information updated as illustrated in FIG. 11.

Subsequently, at step S1408, the control unit 105 detects that the operator has selected a menu item “Stapling” from the exception setting level menu 1503 shown in FIG. 15A using the operation unit 104. The control unit 105 then instructs the exception setting display unit 103 to update the exception setting level-based display in the job list screen to a display for “Stapling”. At that time, since, as described above, the sheet information regarding stapling was updated to “1-3” at step S1111, a value “1-3” is displayed in the sheet information field on the screen.

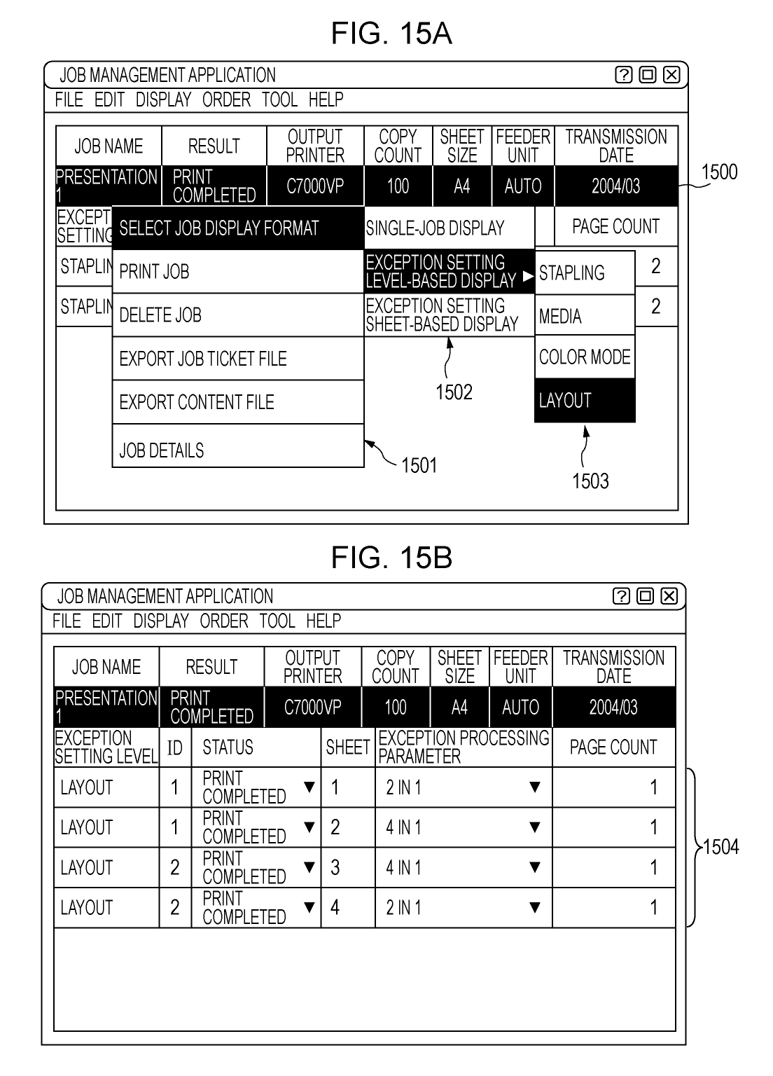

Subsequently, at step S1409, as shown in FIG. 17A, the control unit 105 detects a sheet range to be processed 1701 of the exception setting choice to be edited, which is updated by the operator using the operation unit 104. In FIG. 17A, the operator updates the sheet information for the job-sub ticket ID “1” from “1-3” to “1-2”. Thereafter, the control unit 105 instructs the exception setting editing unit 110 to perform a division process on the exception setting choice in accordance with the detection result and instructs the exception setting display unit 103 to display the updated exception setting choice 1702 in the job list screen, as shown in FIG. 17B. Thus, a sub-ticket ID “3” is newly generated for the sheet information “3”.

Example processing performed by the job management apparatus 100 according to the second embodiment for the operation processes at steps S1407 to S1409 is described below with reference to FIG. 11.

When the operator instructs editing of the exception setting choice using the operation unit 104, the exception setting editing unit 110 updates the exception setting choice in accordance with the instruction. At that time, the exception setting information management unit 114, at step S1101, detects the updating of the exception setting choice.

Subsequently, at step S1102, the exception setting information management unit 114 determines whether the sheet information is updated.

In this example, since the sheet information is updated through the screen shown in FIG. 17B, the processing proceeds to step S1103. At step S1103, the exception setting information management unit 114 determines whether the exception setting level of the updated exception setting choice is “Layout”.

In this example, since the exception setting level of the updated exception setting choice is “Stapling” as shown in FIGS. 17A and 17B, the processing proceeds to step S1104. At step S1104, the exception setting information management unit 114 determines whether the number of the exception setting choices in the final process is increased, decreased, or unchanged.

In this example, as shown by the sheet range to be processed 1701 for the exception setting level ID “1” in FIG. 17A, the sheet range to be processed is changed from “1-3” to “1-2”. In this case, the sheet range of a sub-job ticket having ID=1 is changed. Accordingly, the sheet ranges regarding the exception setting level in the final process are “1-2”, “3”, and “4-5”. Since the number of the exception setting choices is increased, the processing proceeds to step S1105.

Subsequently, at step S1105, the exception setting information management unit 114 generates a new sub-job ticket ID for the increased exception setting choices. In this example, a sub-job ticket “3” is newly generated.

Subsequently, at step S1107, the exception setting information management unit 114 updates the sheet range for the other associated exception setting choices on the basis of the updating of the sheet range shown in FIG. 17A and generates a new exception setting choice. Thus, the exception setting information management unit 114 updates the exception setting information.

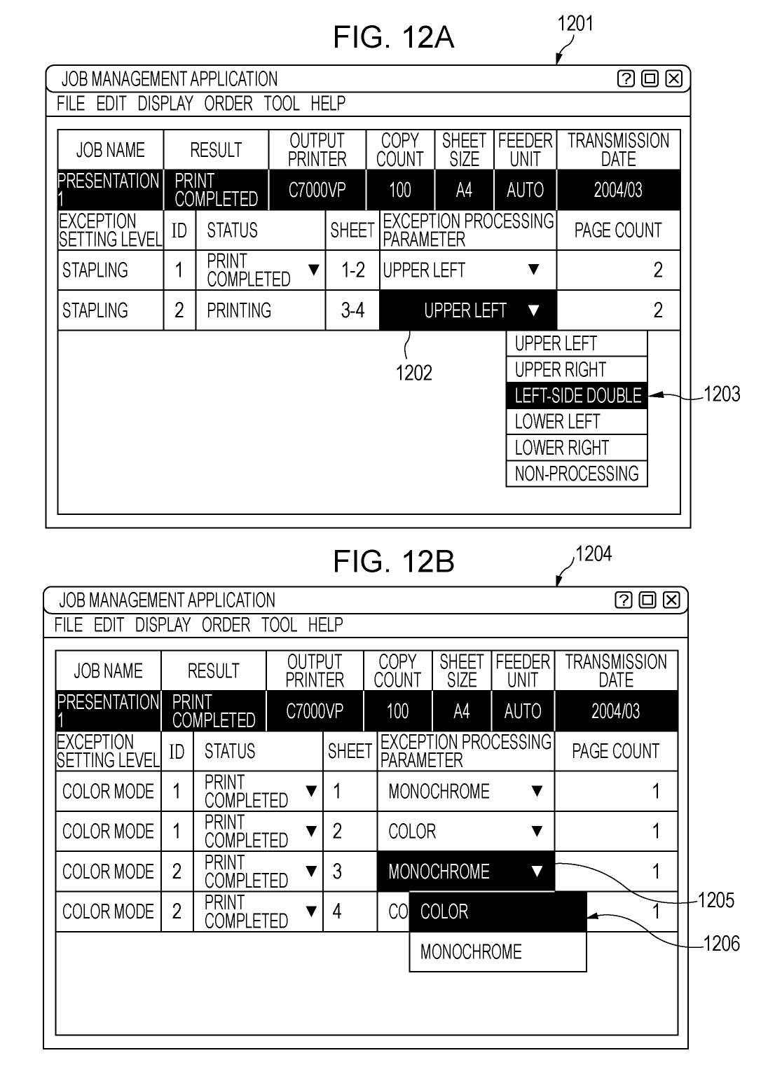

A particular example is described below. The exception setting information before the processing according to the second embodiment is performed is shown in FIGS. 7A to 7C. In the processing according to the second embodiment, when the layout for the exception setting choice ID “12” is changed from “4-in-1” to “2-in-1”, the processes at steps S1108 to S1111 are performed. As a result, as shown in FIGS. 7A to 7C, the sheet to be processed for the exception setting choice ID “12” is changed from “2” to “2-3”. In accordance with this change, the sheet information for other layouts is changed as follows. For the exception setting choice ID “13”, the sheet information is changed from “3” to “4”. For the exception setting choice ID “14”, the sheet information is changed from “4” to “5” (this process corresponds to the process at step S1108). In accordance with this change, other associated exception setting choice IDs are detected (steps S1109 and S1110). In the second embodiment, the exception setting choice IDs are used for updating. Updating is performed as follows. For the exception setting choice ID “1”, the sheet information is changed from “1-2” to “1-3”. For the exception setting choice ID “2”, the sheet to be processed is changed from “3-4” to “4-5”. Similarly, for the exception setting choice ID “4”, the sheet information is changed from “2” to “2-3”. For the exception setting choice ID “5”, the sheet information is changed from “4” to “5”. For the exception setting choice ID “6”, the sheet information is changed from “4” to “5”. Subsequently, after the sheet information regarding “Stapling” displayed on the screens shown in FIGS. 17A and 17B is updated, the exception setting information is changed as shown in FIG. 13A (step S1107) and is updated (step S1112).

FIG. 13A illustrates an example of exception setting information 1301 updated in the processing performed at steps S1407 to S1409 according to the second embodiment.

Subsequently, at step S1113, the exception setting information management unit 114 updates the exception setting link information. FIG. 13B illustrates an example of exception setting link information 1302 updated in the processing performed at steps S1407 to S1409 according to the second embodiment.

Subsequently, at step S1114, the job ticket generation unit 108 regenerates a sub-job ticket.

Subsequently, at step S1115, for example, the job ticket management unit 112 determines whether an unnecessary sub-job ticket is present.

As a result of the determination at step S1115, if an unnecessary sub-job ticket is present, the processing proceeds to step S1116. At step S1116, the job ticket management unit 112 deletes the unnecessary sub-job ticket from the job ticket DB 113. An unnecessary sub-job ticket is a sub-job ticket corresponding to a sub-job ticket ID that is combined and is determined to be deleted at step S1106.

However, if, at step S1115, it is determined that an unnecessary sub-job ticket is not present or if the processing at step S1116 is completed, the processing illustrated by the flow chart given in FIG. 11 is completed.

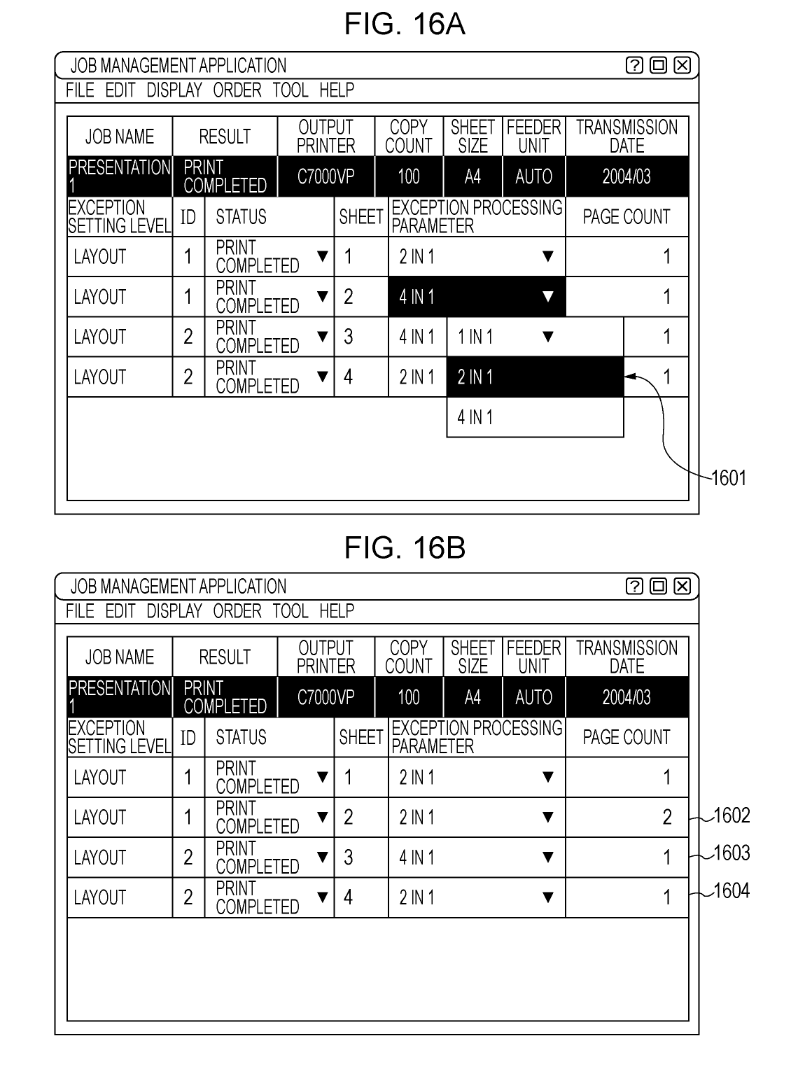

FIG. 18 is a flow chart of an example of a third operation processing procedure performed by the job management apparatus 100 when exception setting choices are displayed on a display unit 116 on an exception setting level basis, and a job for which print processing is completed is edited for the exception setting level, according the second embodiment. At that time, the processing illustrated in a flow chart shown in FIG. 18 is performed under the control of the control unit 105 shown in FIG. 1, for example.

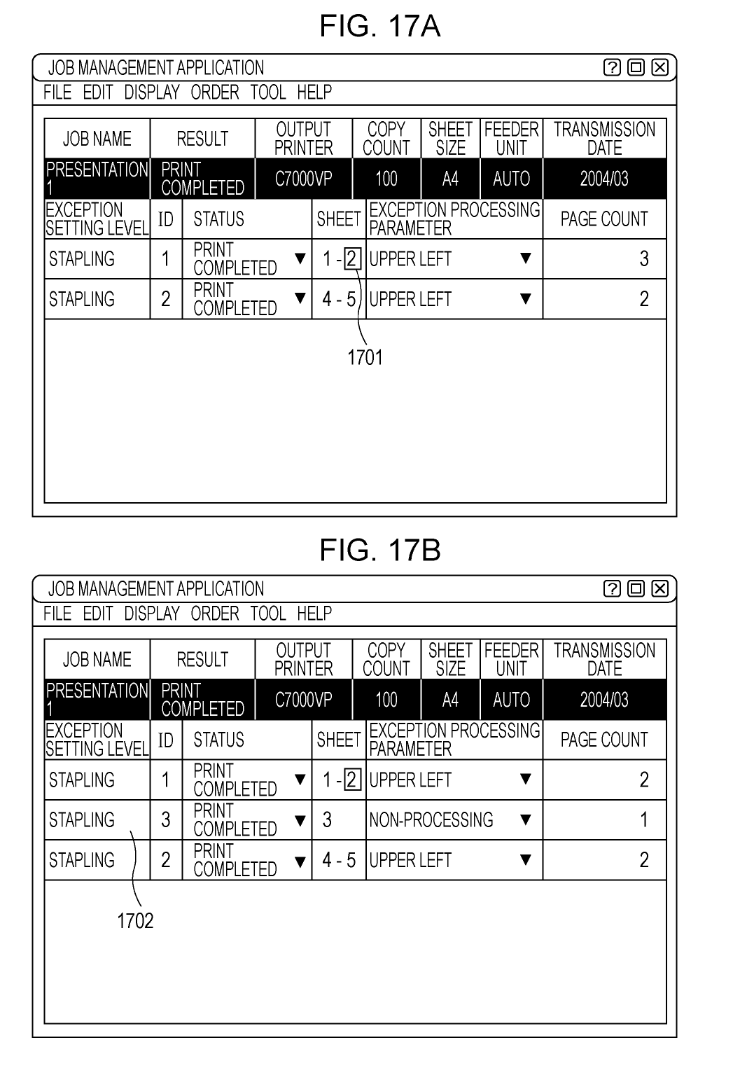

FIGS. 19A and 19B are schematic illustration of example screens provided by the job management application and relating to an exemplary operation of the job management application in the example of the third operation processing procedure illustrated in FIG. 18.

In the following description, for example, the range for the exception setting level “Stapling” is changed. Thus, two booklets are generated in place of three booklets.

In this example, at step S1801, the control unit 105 starts the job management application so as to control the job display unit 102. Thus, a job list screen illustrated in FIG. 19A is displayed on the display unit 116. Thereafter, the control unit 105 selects a job 1900 which is selected by an operator through the operation unit 104, as shown in FIG. 19A.

Subsequently, at step S1802, when the control unit 105 detects a right-click of a pointing device of the operation unit 104 performed by the operator, the control unit 105 instructs the job display unit 102 to display a function menu (not shown) in the job list screen. Thereafter, when the operator selects a menu item “Select job display format” from the function menu using the operation unit 104, the control unit 105 instructs the job display unit 102 to display a job display format menu (not shown).

Subsequently, at step S1803, the control unit 105 detects that the operator has selected a menu item “Exception setting level-based display” from the job display format menu using the operation unit 104. The “Exception setting level-based display” means a process in which print settings of a job is displayed on an exception setting level basis. Thereafter, the control unit 105 instructs the job display unit 102 to display an exception setting level menu (not shown).

Subsequently, at step S1804, when the operator selects the menu item “Stapling” from the exception setting level menu using the operation unit 104, the control unit 105 detects this selection. The control unit 105 then instructs the exception setting display unit 103 to display exception setting choice information 1901 for the exception setting level (‘Stapling’) in the job list screen, as illustrated in FIG. 19A.

Subsequently, at step S1805, the control unit 105 detects a sheet range 1902 of the exception setting choice that the operator changed using the operation unit 104, as shown in FIG. 19A. In this example, the sheet range “4-5” of the exception setting choice having ID=2 is changed to “3-5”.

Subsequently, at step S1806, the control unit 105 instructs the exception setting editing unit 110 to perform an automatic combining process of exception setting levels and instructs the exception setting display unit 103 to update the job list screen to display the result of the combining process. More specifically, in this example, an independent exception setting choice 1903 of “Stapling” shown in FIG. 19A is combined with an exception setting choice 1904 of “Stapling” and is automatically updated into an exception setting choice 1905 as shown in FIG. 19B.

Example processing performed by the job management apparatus 100 according to the second embodiment for the operation process illustrated in FIG. 18 is described below.

When the operator instructs editing of the exception setting choice using the operation unit 104, the exception setting editing unit 110 updates the exception setting in accordance with the instruction. At that time, the exception setting information management unit 114, at step S1101, detects the updating of the exception setting choice.

Subsequently, at step S1102, the exception setting information management unit 114 determines whether the sheet information is updated.

In this example, since the sheet information is updated, the processing proceeds to step S1103. At step S1103, the exception setting information management unit 114 determines whether the exception setting level of the updated exception setting choice is “Layout”.

In this example, since the exception setting level of the updated exception setting choice is “Stapling” as shown in FIGS. 19A and 19B, the processing proceeds to step S1104. At step S1104, the exception setting information management unit 114 determines whether the number of the exception setting choices in the final process is increased, decreased, or unchanged.

In this example, as shown by the exception setting choice 1904, the sheet range to be processed is changed from “4-5” to “3-5”. In this case, the sheet range of a sub-job ticket having ID=2 is changed. Accordingly, as shown in FIG. 19A, the sheet ranges for the exception setting level in the final process are “1-2”, “3”, and “3-5”, and therefore, overlapping occurs. Accordingly, a combining process is performed, as shown in FIG. 19B. As a result, it is determined that the number of the exception setting choices (sub-job tickets) is decreased. Thus, the processing proceeds to step S1106.

At step S1106, the exception setting information management unit 114 determines that a smaller sub-job ticket ID remains after completion of a combining process. More specifically, in FIG. 19A, the sub-job ticket ID of the exception setting choice 1903 is 3, while the sub-job ticket ID of the exception setting choice 1904 is 2. Accordingly, as shown in FIG. 19B, the sub-job ticket “2” is used after the combining process is completed.

Since the processes at step S1107 and steps S1112 to S1115 have been described above, detailed descriptions thereof are not repeated.

As a result of the determination at step S1115, if an unnecessary sub-job ticket is present, the processing proceeds to step S1116. At step S1116, the job ticket management unit 112 deletes the unnecessary sub-job ticket from the job ticket DB 113.

However, if, at step S1115, it is determined that an unnecessary sub-job ticket is not present or if the processing at step S1116 is completed, the processing illustrated by the flow chart given in FIG. 11 is completed.

If it is determined at step S1104 shown in FIG. 11 that the number of the exception setting choices in the final process is not increased or decreased (plus or minus 0), the need for re-execution of the linking process of the exception setting choices is eliminated. Accordingly, the processes subsequent to step S1112 are performed.

According to the second embodiment, a mechanism is provided that enables an exception setting choice to be edited for each of the exception setting levels in a print job having the exception settings. Accordingly, the operator can easily edit print settings for each of the exception setting levels and the occurrence of a setting mistake can be reduced, and therefore, the processing efficiency can be increased. Thus, according to the second embodiment, the job management apparatus 100 can provide an easy operation of a printing process regarding the exception setting and provide a comfortable printing process environment. In addition, the operator can easily change the print setting on an exception setting level basis.

### Third Embodiment

A third embodiment of the present invention is described below. A job management apparatus according to the third embodiment has a functional structure that is the same as or alternatively similar to that of the job management apparatus 100 according to the first embodiment illustrated in FIG. 1. In addition, a print processing system according to the third embodiment has a configuration that is the same as or alternatively similar to that of the print processing system according to the first embodiment illustrated in FIG. 2. However, the following description delineates how the third embodiment differs from the first and second embodiments.

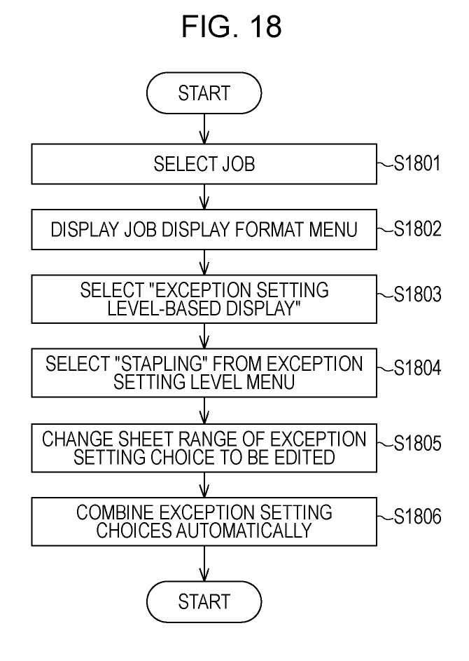

Exemplary processing of a job management apparatus 100 according to the third embodiment is described next with reference to FIGS. 20 to 24 and FIG. 33.

FIG. 20 is a flow chart of an example of an operation processing procedure performed by the job management apparatus 100 when exceptional setting choices are displayed on a display unit 116 on an exception setting level basis, and a job for which print processing is completed is reprinted on an exception setting level basis, according the third embodiment. At that time, the processing illustrated in a flow chart shown in FIG. 20 is performed under the control of the control unit 105 shown in FIG. 1, for example.

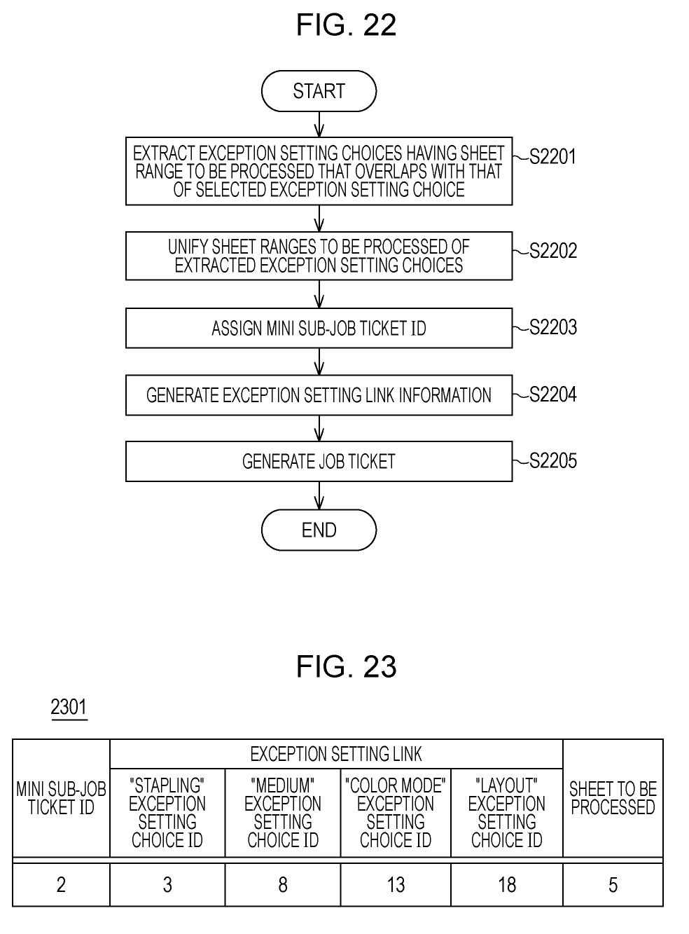

FIGS. 24A and 24B are schematic illustrations of a job management application and an exemplary operation of the job management application related to the example operation processing procedure illustrated in FIG. 20.

The case where a sheet range “4-5” of an exception setting choice 2401 shown in FIG. 24A is reprinted is described next with reference to FIG. 20.

At step S2001, when exceptional setting choices are displayed on the display unit 116 for one of the exception setting levels, the control unit 105 detects that the operator has selected, using the operation unit 104, a field “Status” of an exception setting choice to be reprinted for the exception setting level (“Stapling” in this example). Thereafter, the control unit 105, for example, instructs the exception setting display unit 103 to display a status menu. In the example shown in FIG. 24A, a “Status” field of the exception setting choice 2401 is selected, and therefore, a status menu 2402 is displayed.

Subsequently, at step S2002, the control unit 105 detects that the operator has selected an item “Reprint” from the status menu using the operation unit 104. The control unit 105 then performs control so that the job information management unit 111 selects the corresponding sub-job ticket and transmits the sub-job ticket to the MFP 220 shown in FIG. 2 via the job transmission and reception unit 101.

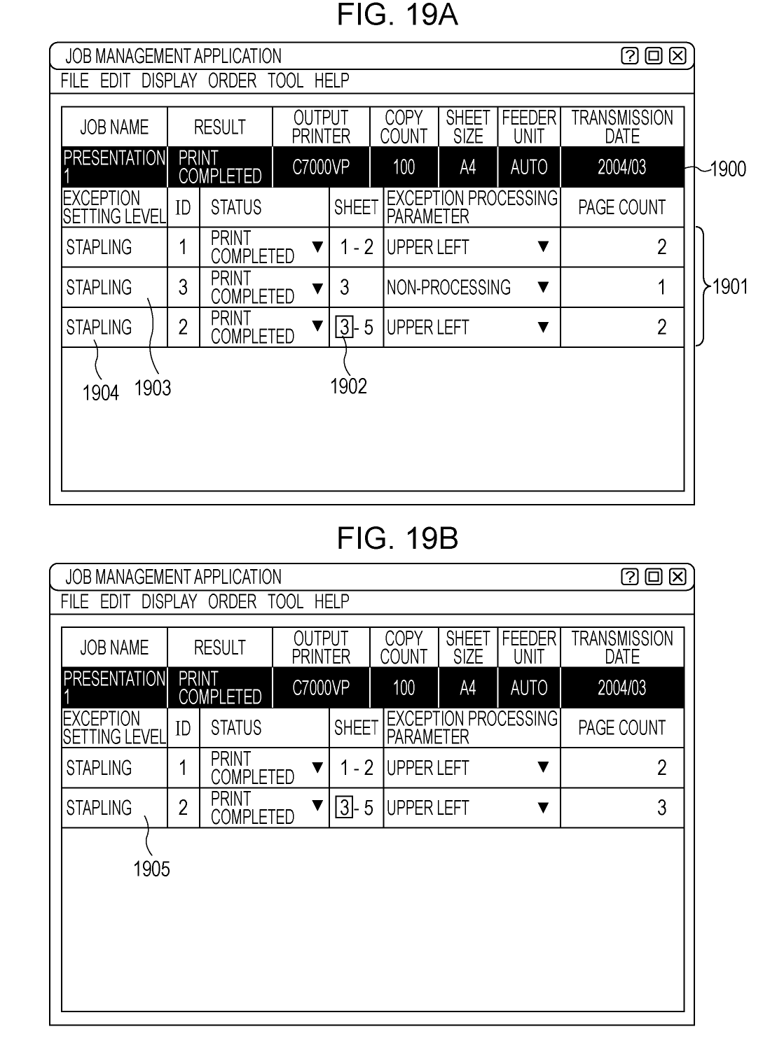

Exemplary processing performed when the job management apparatus 100 according to the third embodiment transmits the sub-job ticket to the MFP 220 is described next with reference to FIG. 21.

FIG. 21 is a flow chart of exemplary reprint processing performed by the job management apparatus 100 according to the third embodiment for each of the exception setting choices. At that time, the processing illustrated in a flow chart shown in FIG. 21 is performed under the control of the control unit 105 shown in FIG. 1, for example.

In the transmission process of the sub-job ticket to the MFP 220, the exception setting information management unit 114, at step S2101, detects an exception setting reprint instruction from the operator through the operation unit 104.

Subsequently, at step S2102, the exception setting information management unit 114 detects a sub-job ticket ID associated with the exception setting choice selected by the operator using the operation unit 104. In the example shown in FIGS. 24A and 24B, a sub-job ticket ID “2” is detected.

Subsequently, at step S2103, the exception setting information management unit 114 determines whether the selected exception setting choice is that of the final process.

For example, as illustrated in the exception setting choice 2401 in FIG. 24A, when reprint for the sub-job ticket ID “2” is instructed, it is determined that the exception setting choice 2401 is that of the final process. Accordingly, the processing proceeds to step S2104.

At step S2104, the job ticket management unit 112 selects the sub-job ticket using the associated sub-job ticket ID.

Subsequently, at step S2105, the job transmission and reception unit 101 transmits the sub-job ticket selected at step S2104 to the MFP 220 shown in FIG. 2. After the process at step S2105 is completed, the processing illustrated by the flow chart given in FIG. 21 is completed.

The case where a sheet range “5” of an exception setting choice 2403 for “Layout” shown in FIG. 24B is reprinted is described next with reference to FIG. 20.

At step S2001, when exception setting choices are displayed on the display unit 116 for one of the exception setting levels, the control unit 105 detects that the operator has selected, using the operation unit 104, a field “Status” of the exception setting choice to be printed for the exception setting level (“Layout” in this example). Thereafter, the control unit 105, for example, instructs the exception setting display unit 103 to display a status menu. In the example shown in FIG. 24B, a “Status” field of the exception setting choice 2403 is selected, and therefore, a status menu 2404 is displayed.

Subsequently, at step S2002, the control unit 105 detects that the operator has selected an item “Reprint” from the status menu using the operation unit 104. The control unit 105 then instructs the job ticket generation unit 108 to generate a mini sub-job ticket for printing only a sheet to which the selected exception setting choice is applied. The control unit 105 then performs control so that the mini sub-job ticket is transmitted to the MFP 220 shown in FIG. 2 via the job transmission and reception unit 101.

Exemplary processing performed when the job management apparatus 100 according to the third embodiment transmits the mini sub-job ticket to the MFP 220 is described next with reference to FIG. 21.

In the transmission process of the mini sub-job ticket to the MFP 220, the exception setting information management unit 114, at step S2101, detects an exception setting reprint instruction from the operator through the operation unit 104.

Subsequently, at step S2102, the exception setting information management unit 114 detects a sub-job ticket ID associated with the exception setting choice selected by the operator using the operation unit 104. In this case, a sub-job ticket ID “2” is detected.

Subsequently, at step S2103, the exception setting information management unit 114 determines whether the selected exception setting choice is that of the final process.

As a result of the determination at step S2103, if the selected the exception setting level is not that of the final process, the processing proceeds to step S2106. Thus, if the “Layout” process is not the final process, the processing proceeds to step S2106.

At step S2106, the exception setting information management unit 114 determines whether the sheet information of the selected exception setting choice is the same as that in the associated sub-job ticket. As a result of the determination at step S2106, if the sheet information of the selected exception setting level is the same as that in the associated sub-job ticket, the processes at steps S2104 and S2105 are performed. In this way, the selected sub-job ticket is transmitted to the MFP 220.

In addition, as shown by the exception setting level 2403 in FIG. 24B, if the sheet range to be processed of the selected exception setting level is smaller than that of the associated sub-job ticket, it is determined at step S2106 that the sheet range of the selected exception setting choice is not the same as that in the associated sub-job ticket (that is, the sheet range to be processed of the selected exception setting level is different from that in the associated sub-job ticket). In this case, the processing proceeds to step S2107.

At step S2107, the job ticket generation unit 108 generates a mini sub-job ticket.

Subsequently, at step S2108, the job transmission and reception unit 101 transmits the mini sub-job ticket generated at step S2107 to the MFP 220 shown in FIG. 2. After the process at step S2108 is completed, the processing illustrated by the flow chart given in FIG. 21 is completed.

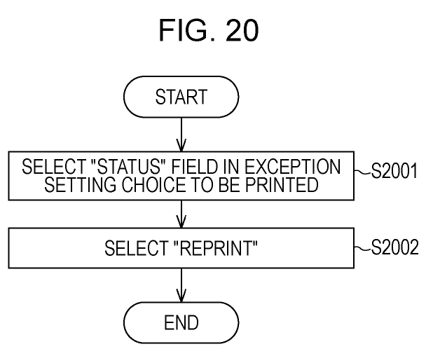

The mini sub-job ticket generation process performed at step S2107 shown in FIG. 21 is described in more detail next. FIG. 22 is a flow chart of a detailed processing procedure of the mini sub-job ticket generation process performed at step S2107 shown in FIG. 21.

At step S2201, first, the exception setting information management unit 114 extracts all of the exception setting choices having a sheet range to be processed that overlaps with that of the selected exception setting choice. In this example, the sheet range to be processed of the selected exception setting choice is “5”. Accordingly, the exception setting choices having the exception setting choice IDs “3”, “8”, “13”, and “18” each including a sheet “5” are extracted from the exception setting information illustrated in FIG. 13A.

Subsequently, at step S2202, the exception setting information management unit 114 unifies the sheet ranges to be processed of the exception setting levels extracted at step S2201. For example, as shown in FIG. 13A, since the sheet range to be processed for the exception setting choice ID “3” is “4-5”, the sheet range is unified to “5”.

Subsequently, at step S2203, the exception setting information management unit 114 assigns a new mini sub-job ticket ID to the unified sheet range to be processed.

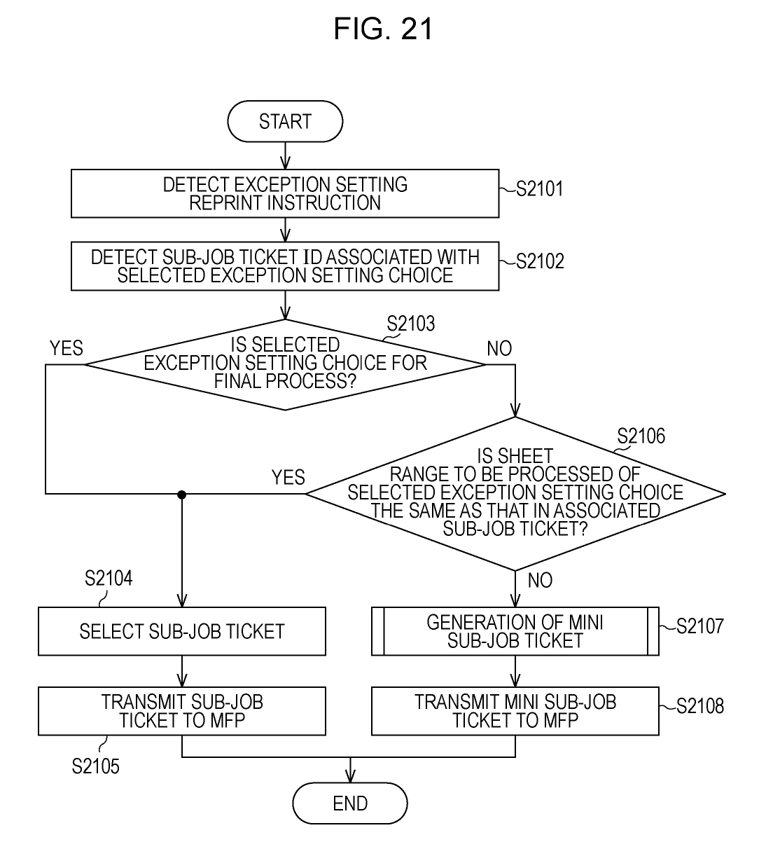

Subsequently, at step S2204, the exception setting information management unit 114 associates the exception setting choices having the sheet range within the sheet range of the mini sub-job ticket with each other so as to generate exception setting link information. FIG. 23 illustrates an example of exception setting link information 2301 generated at step S2204 in FIG. 22.

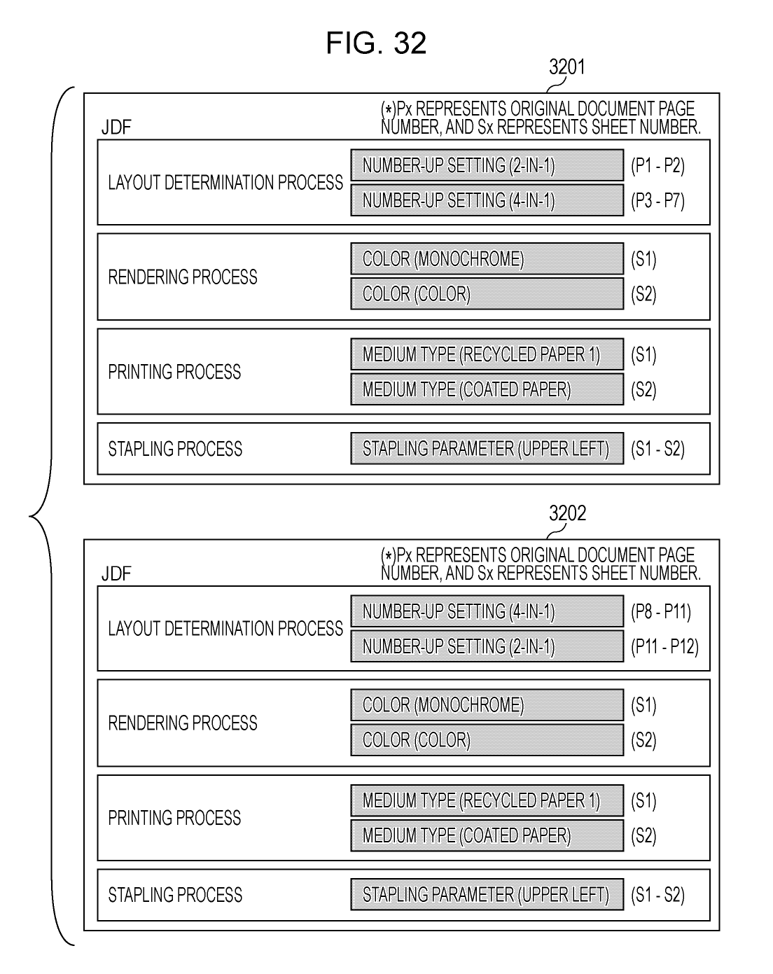

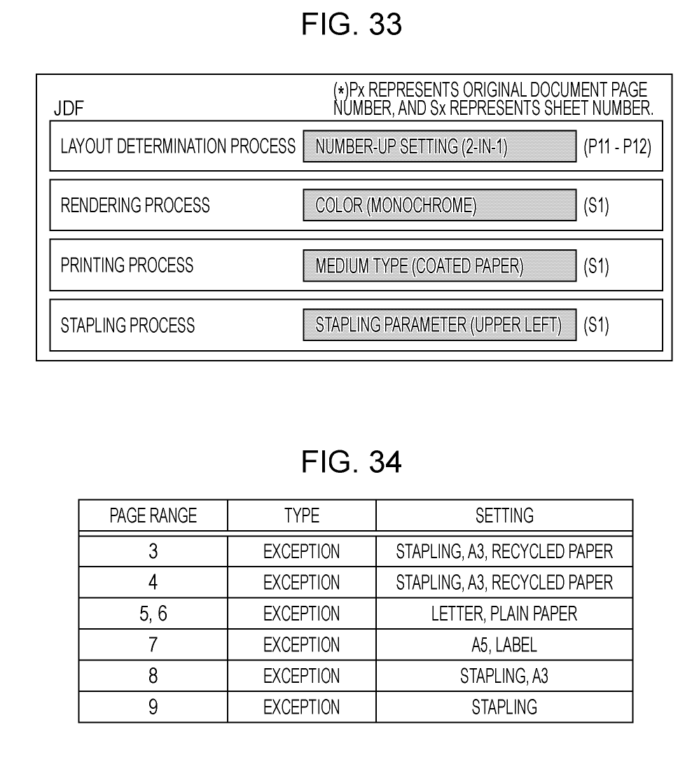

Subsequently, at step S2205, the job ticket generation unit 108 generates a mini sub-job ticket on the basis of the exception setting link information 2301 generated at step S2204. FIG. 33 is a schematic illustration of an example mini sub-job ticket.

After the process at step S2205 is completed, the processing illustrated by the flow chart given in FIG. 22 is completed.

According to the third embodiment, a mechanism is provided that enables an exception setting choice to be reprinted for each of the exception setting levels in a print job having exception settings. Accordingly, the operator can easily perform a reprint process for each of the exception setting choices and the occurrence of a setting mistake can be reduced, and therefore, the processing efficiency can be increased. Thus, according to the third embodiment, the job management apparatus 100 can provide an easy operation of a printing process regarding the exception setting and provide a comfortable printing process environment. In addition, the operator can easily change the print settings on an exception setting level basis.

### Fourth Embodiment

A fourth embodiment of the present invention is described below. A job management apparatus according to the fourth embodiment has a functional structure that is the same as or alternatively similar to that of the job management apparatus 100 according to the first embodiment illustrated in FIG. 1. In addition, a print processing system according to the fourth embodiment has a configuration that is the same as or alternatively similar to that of the print processing system according to the first embodiment illustrated in FIG. 2. However, the following description delineates how the fourth embodiment differs from the embodiments described above.

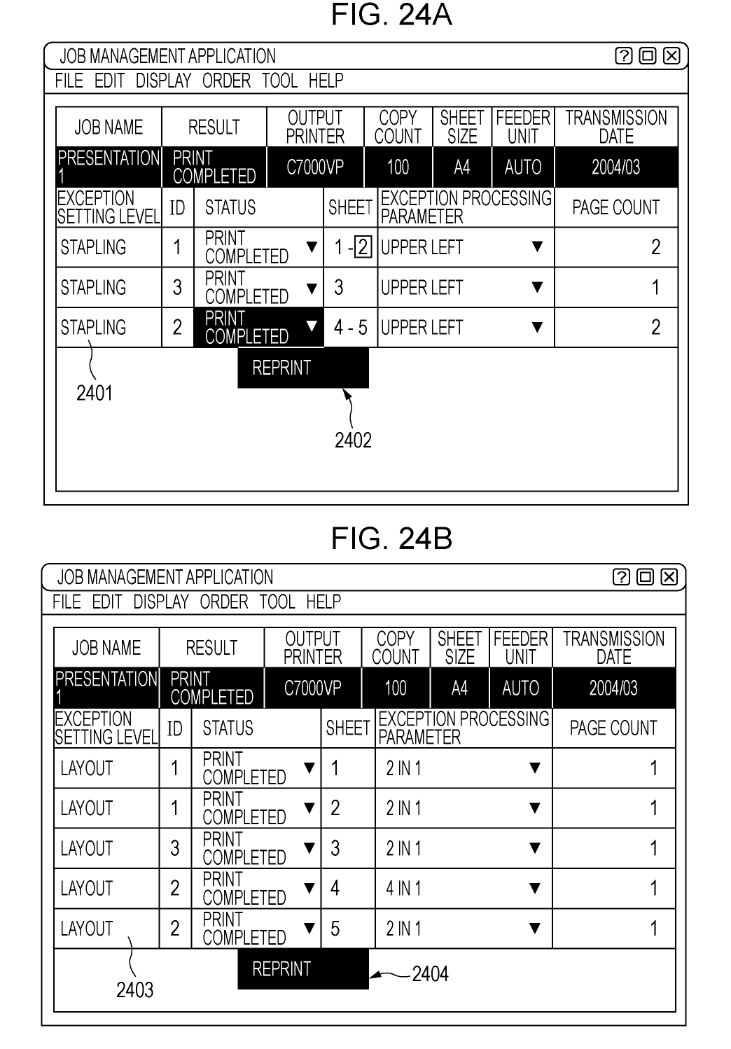

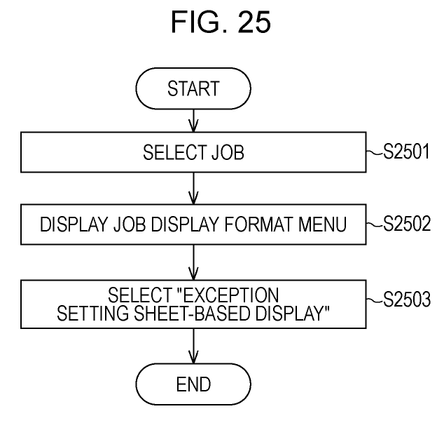

Exemplary processing of a job management apparatus 100 according to the fourth embodiment is described next with reference to FIGS. 25, 26A, and 26B.

FIG. 25 is a flow chart of an exemplary processing procedure performed by the job management apparatus 100 when exception setting choices are displayed on a display unit 116 on an exception setting level basis, according the fourth embodiment. In FIG. 25, the exception setting level is a “Sheet”. At that time, the processing illustrated in a flow chart shown in FIG. 25 is performed under the control of the control unit 105 shown in FIG. 1, for example.

FIGS. 26A and 26B are schematic illustrations of a job management application and an exemplary operation of the job management application regarding the exemplary processing procedure illustrated in FIG. 25.

For example, the case where a “single-job display” mode in which print settings of a print job are displayed on a job-to-job basis is changed to an “exception setting sheet-based display” mode in which exception setting choices of a print job are displayed for a sheet or for a sheet range is described next with reference to FIG. 25.

At step S2501, first, the control unit 105 starts a job management application 2601 shown in FIG. 26A so as to control the job display unit 102. Thus, a job list screen 2602 is displayed on the display unit 116. Thereafter, the control unit 105 selects a job 2603 which is selected by an operator through the operation unit 104.

Subsequently, at step S2502, when the control unit 105 detects a right-click of a pointing device of the operation unit 104 performed by the operator, the control unit 105 instructs the job display unit 102 to display a function menu 2604 in the job list screen 2602. Thereafter, when the operator selects a menu item “Select job display Format” from the function menu 2604 using the operation unit 104, the control unit 105 instructs the job display unit 102 to display a job display format menu 2605, as illustrated in FIG. 26A.

Subsequently, at step S2503, the control unit 105 detects that the operator has selected a menu item “Exception setting sheet-based Display” from the job display format menu 2605 using the operation unit 104. The “Exception setting sheet-based display” represents a mode in which exception setting choices of a job are displayed for a sheet or a sheet range. Thereafter, as shown in FIG. 26B, the control unit 105 instructs the exception setting display unit 103 to display exception setting choice information 2606 for a sheet or a sheet range in the job list screen 2602.

In the exception setting choice information 2606 shown in FIG. 26B, a reference numeral “2607” denotes information about a sheet or a sheet range. A reference numeral “2608” denotes a sub-job ticket ID. In addition, in FIG. 26B, a reference numeral “2609” denotes a print processing status. A reference numeral “2610” denotes the details of the exception setting for the target sheet or the target sheet range, that is, exception processing parameters for the exception setting sheets.

According to the fourth embodiment, a mechanism is provided that enables exception setting choices to be edited on an exception setting level basis and to be displayed for each sheet. Accordingly, the operator can easily examine the exception print settings, and therefore, the processing efficiency can be increased. Thus, according to the fourth embodiment, the job management apparatus 100 can provide an easy operation of a printing process regarding the exception setting and provide a comfortable printing process environment. In addition, the operator can easily change the print settings on an exception setting level basis.

### Fifth Embodiment

A fifth embodiment of the present invention is described below. A job management apparatus according to the fifth embodiment has a functional structure that is the same as or alternatively similar to that of the job management apparatus 100 according to the first embodiment illustrated in FIG. 1. In addition, a print processing system according to the fifth embodiment has a configuration that is the same as or alternatively similar to that of the print processing system according to the first embodiment illustrated in FIG. 2. However, the following description delineates how the fifth embodiment differs from the embodiments described above.

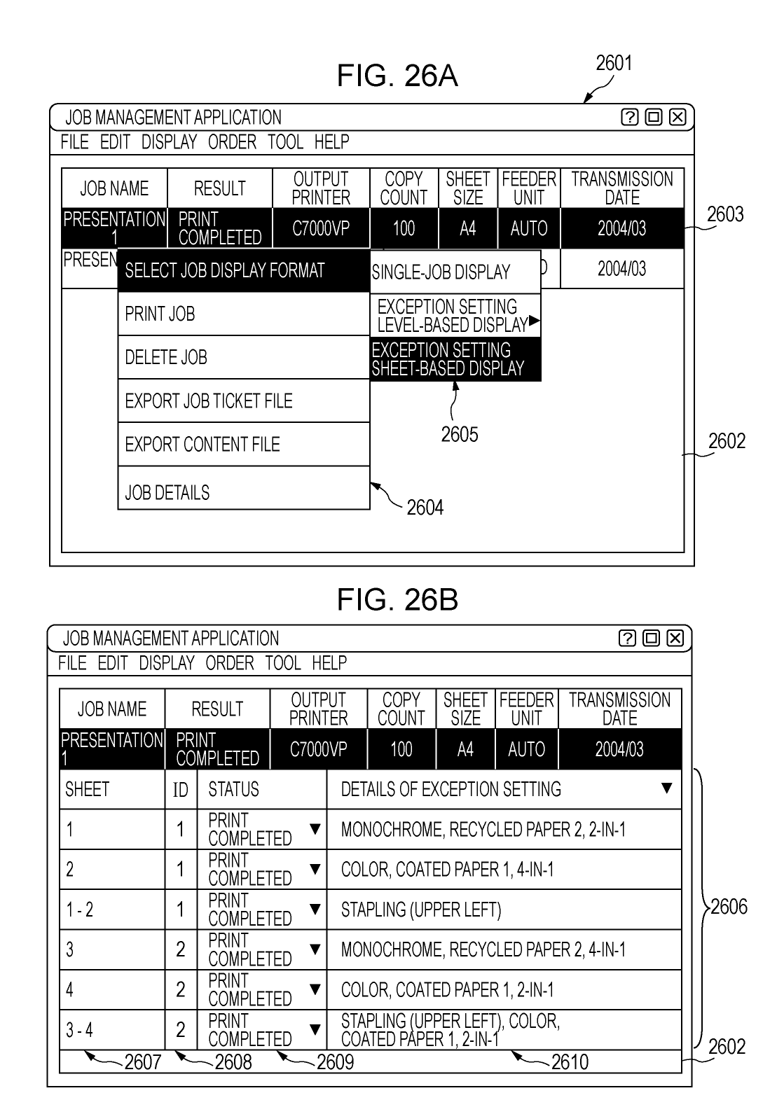

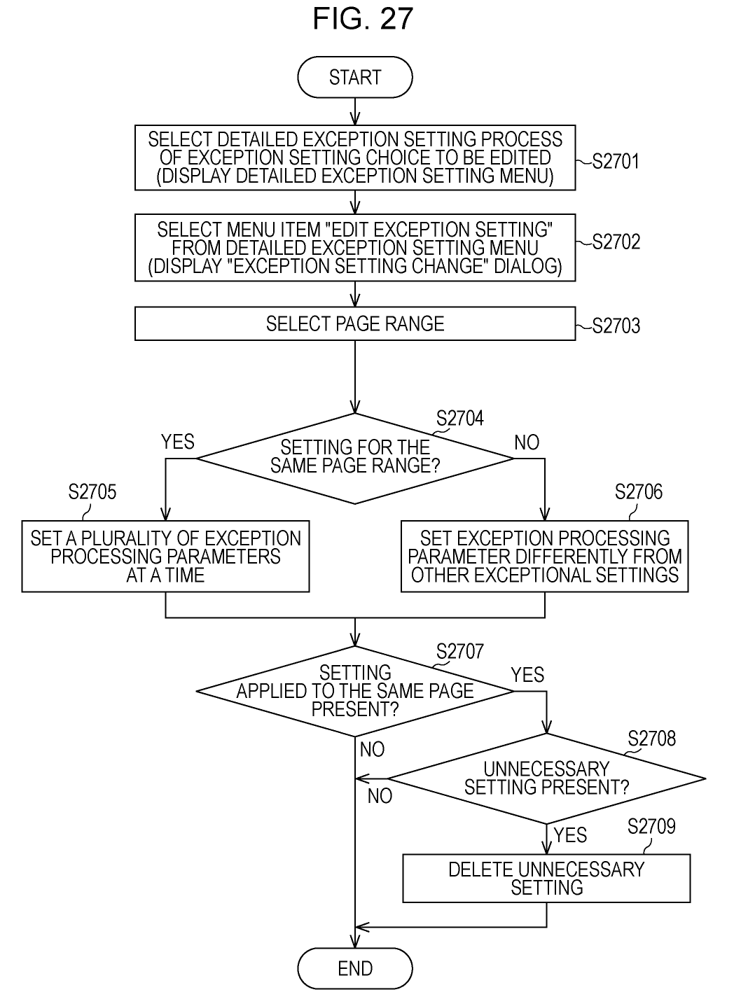

Exemplary processing of a job management apparatus 100 according to the fifth embodiment is described next with reference to FIGS. 27 and 28.

FIG. 27 is a flow chart of an exemplary processing procedure performed by the job management apparatus 100 when exception setting choices are displayed on the display unit 116 on a sheet-to-sheet basis, and a printed job is edited for an original document page or an original document page range, according the fifth embodiment. At that time, the processing illustrated in a flow chart shown in FIG. 27 is performed under the control of the control unit 105 shown in FIG. 1, for example.

FIGS. 28A and 28B are schematic illustrations of a job management application and an exemplary operation of the job management application regarding the exemplary processing procedure illustrated in FIG. 27.

Hereinafter, description is made with reference to the case where an exception setting level “Layout” of “4-in-1” is applied to a page range “3-6” of the original document. In addition, an exception setting level “Color Mode” of “color” and an exception setting level “Medium” of “coated paper 1” are applied to that page range.

First, upon receiving an instruction of the exception setting sheet-based display from an operator through the operation unit 104, the control unit 105 performs a predetermined operation process in accordance with the flow chart shown in FIG. 25. Thus, exception setting choices are displayed on the display unit 116 on an exception setting sheet basis, as shown in FIG. 26B.

Subsequently, at step S2701, upon receiving an instruction of selecting a detailed exception setting process from the operator through the operation unit 104, the control unit 105 instructs the exception setting display unit 103 to display a detailed exception setting menu 2801, as shown in FIG. 28A.

Subsequently, at step S2702, the control unit 105 detects that the operator has selected a menu item “Edit exception setting” from the detailed exception setting menu 2801 using the operation unit 104. Thereafter, for example, as shown in FIG. 28B, the control unit 105 instructs the exception setting display unit 103 to display an “Exception setting change” dialog 2802.

Subsequently, at step S2703, when the operator selects a page range of the original document using the operation unit 104, the control unit 105 detects this selection. In FIG. 28B, the page range is “3-6”.

Subsequently, at step S2704, the control unit 105 determines whether an exception setting choice for the page range determined by the operator using the operation unit 104 is present.

As a result of the determination at step S2704, if the page ranges are the same, the processing proceeds to step S2705. At step S2705, the control unit 105 accepts setting of a plurality of exception processing parameters at a time. In the case of the “Exception setting change” dialog 2802 shown in FIG. 28B, a layout of “4-in-1”, a color mode of “color”, and a medium of “coated paper 1” are set in accordance with the setting for the page range of the original document “3-6”.

However, as a result of the determination at step S2704, if the page ranges are not the same (including the case where one of the exception setting choices has a different page range), the processing proceeds to step S2706. At step S2706, the control unit 105 performs setting of the exception processing parameter differently from other exception settings that are set by the operator through the operation unit 104. In this case, the operator performs a similar operation for other exception settings starting from step S2703 (selection of a page range).

After the process at step S2705 or S2706 is completed, the control unit 105, at step S2707, determines whether settings applied to the same page are present on the basis of a setting list 2803 of the “Print setting change” dialog 2802 shown in FIG. 28B.

As a result of the determination at step S2707, if settings applied to the same page are present, the processing proceeds to step S2708. At step S2708, the control unit 105 determines whether the operator selects an unnecessary setting from among the settings applied to the same page using the operation unit 104.

As a result of the determination at step S2708, if the operator selects an unnecessary setting from among the settings applied to the same page, the control unit 105, at step S2709, deletes the unnecessary setting selected by the operator using the operation unit 104.

However, if it is determined at step S2707 that no settings applied to the same page are present, if the operator does not select an unnecessary setting at step S2708, or if the process at step S2709 is completed, the processing illustrated by the flow chart given in FIG. 27 is completed.

As a result, the exception setting sheet-based display in the job list screen is automatically updated by the exception setting display unit 103.

According to the fifth embodiment, a mechanism is provided that enables exception setting choices edited on an exception setting level basis to be re-edited for each page or page range of the original document in a job having the exception setting. Accordingly, the operator can correctly edit the exceptional print setting and the occurrence of a setting mistake can be reduced, and therefore, the processing efficiency can be increased. Thus, according to the fifth embodiment, the job management apparatus 100 can provide an easy operation of a printing process regarding the exception setting and provide a comfortable printing process environment. In addition, the operator can easily change the print setting on an exception setting level basis.

### Sixth Embodiment

A sixth embodiment of the present invention is described below. A job management apparatus according to the sixth embodiment has a functional structure that is the same as or alternatively similar to that of the job management apparatus 100 according to the first embodiment illustrated in FIG. 1. In addition, a print processing system according to the sixth embodiment has a configuration that is the same as or alternatively similar to that of the print processing system according to the first embodiment illustrated in FIG. 2. However, the following description delineates how the sixth embodiment differs from the embodiments described above.

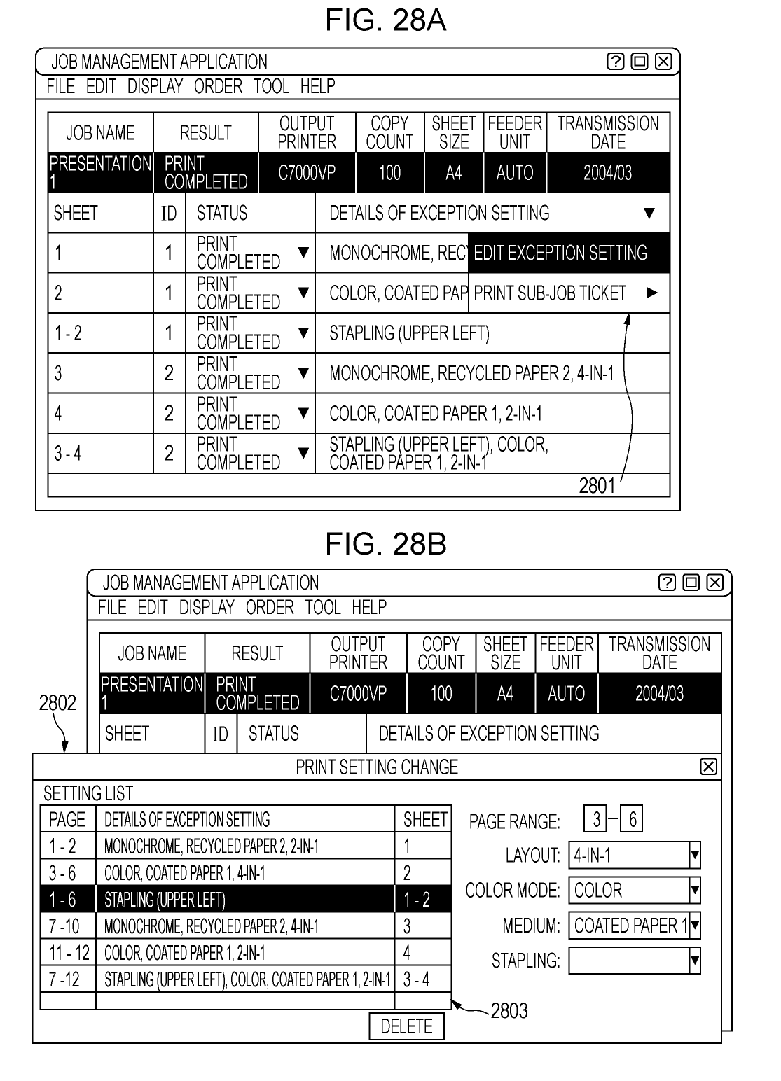

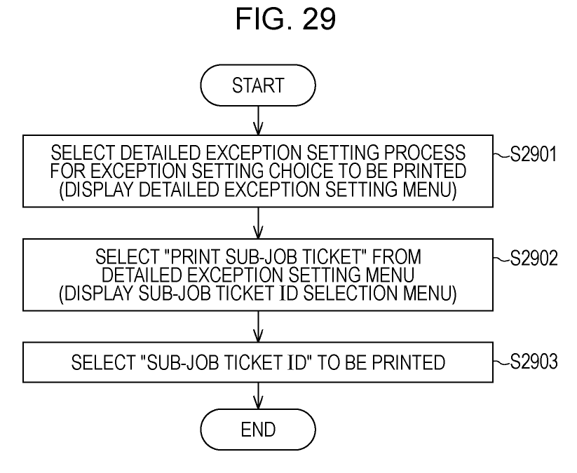

Exemplary processing of a job management apparatus 100 according to the sixth embodiment is described next with reference to FIGS. 29 and 30.

FIG. 29 is a flow chart of an exemplary processing procedure performed by the job management apparatus 100 when exception setting choices are displayed on a display unit 116 on a sheet-to-sheet basis, and a printed job is reprinted for each of the sub-job tickets, according the sixth embodiment. In this embodiment, the sub-job ticket is generated by putting together exception setting choices of the final process of the printed job. At that time, the processes illustrated in a flow chart shown in FIG. 29 are performed under the control of the control unit 105 shown in FIG. 1, for example.

FIGS. 30A and 30B are schematic illustrations of a job management application and an exemplary operation of the job management application regarding the exemplary processing procedure illustrated in FIG. 29.

Hereinafter, description is made with reference to the case where an exception setting level “Stapling” is set as the exception setting of the final process, and only some of sub-job tickets generated for each of the sheet ranges of the exception setting level “Stapling” are reprinted.

In this example, first, the control unit 105 performs an exception setting sheet-based display on the display unit 116.

Subsequently, at step S2901, upon receiving an instruction for selecting a detailed exception setting process from the operator through the operation unit 104, the control unit 105 instructs the exception setting display unit 103 to display a detailed exception setting menu 3001, as shown in FIG. 30A.

Subsequently, at step S2902, the control unit 105 detects that the operator has selected a menu item “Print sub-job ticket” from the detailed exception setting menu 3001 using the operation unit 104. Thereafter, for example, as shown in FIG. 30A, the control unit 105 instructs the exception setting display unit 103 to display a sub-job ticket ID selection menu 3002.

Subsequently, at step S2903, when the operator selects a sub-job ticket ID to be reprinted using the operation unit 104, the control unit 105 detects this selection. In the example shown in FIG. 30A, a sub-job ticket having ID of “2” is selected. As a result, the job information management unit 111 selects a sub-job ticket 3003 shown in FIG. 30B and transmits the selected sub-job ticket 3003 to the MFP 220 shown in FIG. 2 via the job transmission and reception unit 101.

According to the sixth embodiment, a mechanism is provided that enables a reprint to be performed on an exception setting level basis even when display is performed on an exception setting sheet basis. Accordingly, the operator can easily reprint on an exception setting level basis, and the occurrence of a setting mistake can be reduced, and therefore, the processing efficiency can be increased. Thus, according to the sixth embodiment, the job management apparatus 100 can provide an easy operation of a printing process regarding the exception setting and provide a comfortable printing process environment.

Each of the components of the job management apparatus 100 according to the foregoing embodiments shown in FIG. 1 can be realized by execution of programs stored in a RAM and a ROM of a computer. In addition, the processing at each step of a job management method for the job management apparatus 100 (steps shown in FIGS. 3 to 6, FIGS. 10, 11, 14, and 18, FIGS. 20 to 22, and FIGS. 25, 27, and 29) can be realized by execution of programs stored in a RAM and a ROM of a computer. Accordingly, the scope of the present invention is intended to encompass these programs and a computer-readable storage medium storing the programs.

More specifically, the programs are recorded in a recording medium, such as a CD-ROM (compact disk-read only memory). The programs are provided to the computer using the recording medium or a variety of communication media. In addition to a CD-ROM, examples of the recording medium for storing the programs include a flexible disk, a hard disk, a magnetic tape, a magnetooptical disk, a nonvolatile memory card or the like. Example of the communication media for the programs include a communication medium of a computer network (a LAN (local area network), a WAN (wide area network), such as the Internet, or a wireless communication network) system for transmitting program information as carrier waves. In such a case, examples of the communication media include a wired network, such as an optical fiber, and a wireless network.

In addition, the present invention is not limited to a configuration in which a computer realizes the functions of the job management apparatus 100 according to the foregoing embodiments by executing a supplied program. Even when the functions of the job management apparatus 100 according to the foregoing embodiments are realized by the program in cooperation with an operating system (OS) or other application software running on the computer, it is intended that the present invention encompasses such a program. Furthermore, even when the functions of the job management apparatus 100 according to the foregoing embodiments are realized by some of or all of the program processing performed by an add-on expansion board or an add-on expansion unit of the computer, it is intended that the present invention encompasses such a program.

According to the present invention, when a print job having an exception setting applied thereto is subjected to a print process, a comfortable environment of the print process can be provided to users without complicating the operation of the print job.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2007-149557 filed Jun. 5, 2007, which is hereby incorporated by reference herein in its entirety.

What is claimed is:

1. A job management apparatus comprising:
a detecting unit configured to detect a plurality of exception setting items other than print settings applied to an entire print job from the print job;
an instructing unit configured to instruct display of exception setting information for the exception setting items detected by the detecting unit;
a selecting unit configured to allow selection of one of the exception setting items when the instructing unit instructs an exception setting item-based display; and
a display unit configured to display such portion of the exception setting information relating to the exception setting item selected by using the selecting unit.

2. The job management apparatus according to claim 1, wherein the exception setting item selected by using the selecting unit is one of stapling setting, sheet type setting used for printing, color mode setting, and layout setting, and wherein, when the setting item selected by the selecting unit is changed, the display unit displays exception setting information related to the changed setting item.

3. The job management apparatus according to claim 1, wherein the exception setting information represents a sheet range to which the setting item is applied, and wherein the display unit displays the exception setting item selected by the selecting unit and the sheet range to which the selected exception setting item is applied.

4. The job management apparatus according to claim 1, wherein the print job includes a job ticket that indicates a sheet range of exception setting for each of the exception setting items, and the detecting means detects such exception setting from the job ticket.

5. The job management apparatus according to claim 1, further comprising:
a reception unit configured to receive the print job;
an operation unit configured to receive an instruction input by an operator;
an editing unit configured to edit the print job by editing one of an exception processing parameter and a sheet range to which exception setting is applied for each of the exception setting items on the basis of the instruction received from the operation unit.

6. The job management apparatus according to claim 5, wherein, when a sheet range to which exception setting is applied is changed by the editing unit, the display unit displays information indicating that a setting regarding the selected setting item for the entire print job is applied to a sheet that is within a sheet range to which the exception setting is not applied as a result of the change.

7. The job management apparatus according to claim 5, wherein, when a layout setting is changed by the editing unit, the display unit changes a sheet range to which the changed layout setting is applied and displays the changed sheet range.

8. The job management apparatus according to claim 5, further comprising:
a print processing unit configured to perform a reprint process for each of the exception settings on the basis of an instruction received from the operation unit.

9. The job management apparatus according to claim 4, further comprising:
a job ticket interpreting unit configured to identify a plurality of types of processes corresponding to the job ticket and determine a processing order of the processes;
wherein the detecting unit sequentially selects the types of processes in a reverse order of the determined processing order so as to detect the exception setting.

10. The job management apparatus according to claim 1, further comprising:
a sub-job ticket generating unit configured to detect an exception setting from the print job and generate a sub-job ticket on the basis of a sheet range to which each exception setting item is applied;
wherein the display unit performs exception setting item-based display using the sub-job ticket.

11. The job management apparatus according to claim 10, further comprising:
a mini sub-job ticket generating unit configured to generate a mini sub-job ticket by dividing the sub-job ticket for each of other exception settings.

12. A method for managing a job, comprising the steps of:
(a) detecting a plurality of exception setting items other than print settings applied to an entire print job from the print job;
(b) instructing display of exception setting information for the exception setting items;
(c) selecting one of the exception setting items when an exception setting item-based display is instructed in step (b); and
(d) displaying such portion of the exception setting information relating to the setting item selected in step (c)).

13. The method for managing a job according to claim 12, wherein the setting item selected in step (c) is one of stapling setting, sheet type setting used for printing, color mode setting, and layout setting, and wherein, when the setting item selected in step (c) is changed, exception setting information related to the changed setting item is displayed in step (d).

14. The method for managing a job according to claim 12, wherein the exception setting information represents a sheet range to which the setting item is applied, and wherein the setting item selected in step (c) and the sheet range to which the selected setting item is applied are displayed in step (d).

15. The method for managing a job according to claim 12, wherein the print job includes a job ticket that indicates a sheet range of the exception setting for each of the setting items, and the exception setting is detected from the job ticket in step (a).

16. The method for managing a job according to claim 12, further comprising the steps of:
(e) receiving the print job;
(f) receiving an instruction input by an operator;
(g) editing the print job by editing one of an exception processing parameter and a sheet range to which exception setting is applied for each of the exception setting items on the basis of the instruction received in step (f).

17. The method for managing a job according to claim 16, wherein, when a sheet range to which the exception setting is applied is changed in step (g), information indicating that a setting regarding the selected exception setting item for the entire print job is applied to a sheet that is within a sheet range to which exception setting is not applied is displayed as a result of the change in step (d).

18. The method for managing a job according to claim 16, wherein, when a layout setting is changed in step (g), a sheet range to which the changed layout setting is applied is changed, and the changed sheet range is displayed in step (d).

19. The method for managing a job according to claim 16, further comprising the step of:
performing a reprint process for each of the exception settings on the basis of an instruction received in step (f).

20. The method for managing a job according to claim 15, further comprising the step of:
identifying the types of processes of the job ticket and determining the processing order of the processes;
wherein, in step (a), the type of process is sequentially selected in a reverse order of the determined processing order so that the exception setting is detected.

21. The method for managing a job according to claim 12, further comprising the step of:
detecting an exception setting from the print job and generating a sub-job ticket on the basis of a sheet range to which each exception setting item is applied;
wherein exception setting item-based display is performed using the sub-job ticket in step (d).

22. The method for managing a job according to claim 21, further comprising the step of:
generating a mini sub-job ticket by dividing the sub-job ticket for each of other exception settings.

23. A computer readable storage medium storing computer-readable program code for causing a computer to perform the steps of (a) detecting a plurality of exception setting items other than print settings applied to an entire print job from the print job, (b) instructing display of exception setting information for the exception setting items detected in step (a), (c) selecting one of the exception setting items when an exception setting item-based display is instructed in step (b), and (d) displaying such portion of the exception setting information relating to the setting item selected in step (c).
